(19) United States
(12) Patent Application Publication
(10) Pub. No.: US 2024/0053690 A1
(43) Pub. Date: Feb. 15, 2024

(54) LIQUID ELECTROPHOTOGRAPHIC INK COMPOSITIONS

(71) Applicant: Hewlett-Packard Development Company, L.P., Spring, TX (US)

(72) Inventors: Israel Patla, Nes Ziona (IL); Yaron Grinwald, Nes Ziona (IL); Faina Kogan, Nes Ziona (IL); Itay Eyal, Nes Ziona (IL)

(21) Appl. No.: 17/766,421

(22) PCT Filed: Jun. 26, 2020
(86) PCT No.: PCT/US2020/039797

§ 371 Date: Apr. 4, 2022

(30) Foreign Application Priority Data
Nov. 15, 2019 (WO) PCT/US2019/061716

(51) Int. Cl. G03G 5/087; C09D 11/52; C09D 11/037; C09D 11/107; B41M 5/52; G03G 15/10

(52) U.S. Cl. CPC G03G 5/087; C09D 11/52; C09D 11/037; C09D 11/107; B41M 5/52; G03G 15/10

(57) ABSTRACT

Described herein is a method of producing a perovskite material on a substrate by LEP printing comprising: printing a composition comprising a salt AX and a resin in a carrier liquid; printing a composition comprising a salt selected from BX₂ and in BX₄ and a resin in a carrier liquid; and heat treating the printed compositions; or printing a composition comprising a material with a perovskite structure and a resin in a carrier liquid; wherein the resin comprises a copolymer of an alkylene monomer and a monomer having acidic side groups; and/or a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof. Also described is an ink set and a printed substrate.

Electrophotographic printing processes can involve creating an image on a photoconductive surface, applying an ink having charged particles to the photoconductive surface, such that they selectively bind to the image, and then transferring the charged particles in the form of the image to a substrate.

The photoconductive surface may be on a cylinder and may be termed a photo imaging plate (PIP). The photoconductive surface is selectively charged with a latent electrophotographic image having image and background areas with different potentials. For example, an electrophotographic ink composition comprising charged toner particles in a carrier liquid can be brought into contact with the selectively charged photoconductive surface. The charged toner particles adhere to the image areas of the latent image while the background areas remain clean. The image is then transferred to a substrate directly or, more commonly, by being first transferred to an intermediate transfer member, which can be a soft swelling blanket, and then to the substrate.

### BRIEF DESCRIPTION OF THE FIGURES

FIG. 1 shows the fluorescence intensity spectra of cured LEP ink compositions comprising a poly(ethylene-co-glycidyl methacrylate) resin with CsSnBr₂Ion days 2, 7 and 30 after curing and using an excitation wavelength of 400 nm.

FIG. 2 shows the fluorescence intensity spectra of cured LEP ink compositions comprising a poly(ethylene-co-glycidyl methacrylate) resin with MAPbI₃ on days 2, 7 and 30 after curing and using an excitation wavelength of 475 nm.

FIG. 3 shows the fluorescence intensity spectra of cured LEP ink compositions comprising a poly(ethylene-co-glycidyl methacrylate) resin with CsPbBrI₂ on days 2, 7 and 30 after curing and using an excitation wavelength of 460 nm.

FIG. 4 shows the fluorescence life time of cured LEP ink compositions comprising a poly(ethylene-co-glycidyl methacrylate resin with MAPbI₃ (left) and CsPbBrI₂ (right) on days 2, 7 and 30 after curing.

FIG. 5 shows X-ray diffraction patterns for cured LEP ink compositions comprising poly(ethylene-co-glycidyl methacrylate resin with CsSnBr₂ lafter 10-days and 1 month compared with day 2.

FIG. 6 shows X-ray diffraction patterns for cured LEP ink compositions comprising poly(ethylene-co-glycidyl methacrylate resin with MAPbI₃ after 10-days and 1 month compared with day 2.

FIG. 7 shows X-ray diffraction patterns for cured LEP ink compositions comprising poly(ethylene-co-glycidyl methacrylate resin with CsPbBrI₂ after 10-days and 1 month compared with day 2.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “liquid carrier”, “carrier,” or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “liquid electrostatic ink composition” or “liquid electrophotographic composition” generally refers to an ink composition that is typically suitable for use in an electrostatic printing process, sometimes termed an electrophotographic printing process. It may comprise pigment particles having a thermoplastic resin thereon. The electrostatic ink composition may be a liquid electrostatic ink composition, in which the pigment particles having resin thereon are suspended in a carrier liquid. The pigment particles having resin thereon will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrostatic ink composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate, such as a plastic film. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrostatic printing” is a specific type of electrostatic printing in which a liquid composition is employed in the electrophotographic process rather than a powder toner. An electrostatic printing process may involve subjecting the electrostatic composition to an electric field, for example, an electric field having a field gradient of 50-400 V/μm, or more, in some examples, 600-900V/μm, or more.

As used herein, “dispersion” generally refers to a composition comprising solid particles, for example, a thermoplastic resin, suspended in a liquid, wherein the solid particles are not soluble in the liquid at a temperature below 100° C. at 10⁵ Pa. As used herein, a compound is not soluble in a liquid if a saturated solution comprises 5 wt. % or less of the compound, for example, 2 wt. % or less, 1 wt. % or less, 0.1 wt. % or less.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a method of producing a material with a perovskite structure on a substrate wherein the material with a perovskite structure has a chemical formula selected from ABX₃ and A₂BX₆.

The method of producing a material with a perovskite structure on a substrate by liquid electrophotographic (LEP) printing may comprise:
liquid electrophotographically printing onto the substrate a composition comprising a dispersion of a salt AX and a thermoplastic resin in a carrier liquid;
liquid electrophotographically printing onto the substrate a composition comprising a dispersion of a salt BX₂ or a salt BX₄ and a thermoplastic resin in a carrier liquid; and heat treating the printed compositions to form the material with a perovskite structure;
   wherein the material with a perovskite structure has a chemical formula selected from ABX₃ and A₂BX₆
   wherein A is a cation, B is a cation and X is an anion; and
   wherein the thermoplastic resin comprises:
a copolymer of an alkylene monomer and a monomer having acidic side groups; and/or
a copolymer of an alkylene monomer and an ethylenically unsaturated monomer comprising an epoxide; and/or
a copolymer of an alkylene monomer, an ethylenically unsaturated monomer comprising an epoxide, and a monomer selected from a monomer having acidic side groups, a monomer having ester side groups and a mixture thereof.

The method of producing a material with a perovskite structure on a substrate by liquid electrophotographic (LEP) printing may comprise:
liquid electrophotographically printing onto the substrate a composition comprising a dispersion of a salt AX and a thermoplastic resin in a carrier liquid;
liquid electrophotographically printing onto the substrate a composition comprising a dispersion of a salt BX₂ or a salt BX₄ and a thermoplastic resin in a carrier liquid; and
heat treating the printed compositions to form the material with a perovskite structure;
   wherein the material with a perovskite structure has a chemical formula selected from ABX₃ and A₂BX₆
   wherein A is a cation, B is a cation and X is an anion; and
   wherein the thermoplastic resin comprises a copolymer of an alkylene monomer and a monomer having acidic side groups.

The method of producing a material with a perovskite structure on a substrate by liquid electrophotographic printing may comprise:
liquid electrophotographically printing onto the substrate a composition comprising a dispersion of a material with a perovskite structure and a thermoplastic resin in a carrier liquid to form the material with a perovskite structure on the substrate;
   wherein the material with a perovskite structure has a chemical formula selected from ABX₃ and A₂BX₆
   wherein A is a cation, and B is a cation and X is an anion; and
   wherein the thermoplastic resin comprises:
a copolymer of an alkylene monomer and a monomer having acidic side groups; and/or
a copolymer of an alkylene monomer and an ethylenically unsaturated monomer comprising an epoxide; and/or
a copolymer of an alkylene monomer, an ethylenically unsaturated monomer comprising an epoxide, and a monomer selected from a monomer having acidic side groups, a monomer having ester side groups and a mixture thereof.

The method of producing a material with a perovskite structure on a substrate by liquid electrophotographic printing may comprise:
liquid electrophotographically printing onto the substrate a composition comprising a dispersion of a material with a perovskite structure and a thermoplastic resin in a carrier liquid to form the material with a perovskite structure on the substrate;
   wherein the material with a perovskite structure has a chemical formula selected from ABX₃ and A₂BX₆
   wherein A is a cation, and B is a cation and X is an anion; and
   wherein the thermoplastic resin comprises a copolymer of an alkylene monomer and a monomer having acidic side groups.

In another aspect, there is provided an ink set.

The ink set may comprise:
a liquid electrophotographic ink composition comprising a dispersion of a material with a perovskite structure and a thermoplastic resin in a carrier liquid wherein the material with a perovskite structure has a chemical formula selected from ABX₃ and A₂BX₆;
   or
a liquid electrophotographic ink composition comprising a dispersion of a salt AX and a thermoplastic resin in a carrier liquid; and
a liquid electrophotographic ink composition comprising a dispersion of a salt BX₂ or a salt BX₄ and a thermoplastic resin in a carrier liquid;
   wherein A is a cation, and B is a cation and X is an anion; and
   wherein the thermoplastic resin comprises
a copolymer of an alkylene monomer and a monomer having acidic side groups; and/or
a copolymer of an alkylene monomer and an ethylenically unsaturated monomer comprising an epoxide; and/or
a copolymer of an alkylene monomer, an ethylenically unsaturated monomer comprising an epoxide, and a monomer selected from a monomer having acidic side groups, a monomer having ester side groups and a mixture thereof.

The ink set may comprise:
a liquid electrophotographic ink composition comprising a dispersion of a material with a perovskite structure and a thermoplastic resin in a carrier liquid wherein the material with a perovskite structure has a chemical formula selected from ABX₃ and A₂BX₆;
   or
a liquid electrophotographic ink composition comprising a dispersion of a salt AX and a thermoplastic resin in a carrier liquid; and
a liquid electrophotographic ink composition comprising a dispersion of a salt BX₂ or a salt BX₄ and a thermoplastic resin in a carrier liquid;
   wherein A is a cation, and B is a cation and X is an anion; and
   wherein the thermoplastic resin comprises a copolymer of an alkylene monomer and a monomer having acidic side groups.

In a further aspect, there is provided a printed substrate.

The printed substrate may comprise:
a substrate; and
a liquid electrophotographically printed composition comprising a thermoplastic resin and a material with a perovskite structure disposed on the substrate;
   wherein the material with a perovskite structure has a chemical formula selected from ABX₃ and A₂BX₆
   wherein A is a cation, B is a cation and X is an anion; and
   wherein the thermoplastic resin comprises
a copolymer of an alkylene monomer and a monomer having acidic side groups; and/or
a copolymer of an alkylene monomer and an ethylenically unsaturated monomer comprising an epoxide; and/or
a copolymer of an alkylene monomer, an ethylenically unsaturated monomer comprising an epoxide, and a monomer selected from a monomer having acidic side groups, a monomer having ester side groups and a mixture thereof.

The printed substrate may comprise:
a substrate; and
a liquid electrophotographically printed composition comprising a thermoplastic resin and a material with a perovskite structure disposed on the substrate;
   wherein the material with a perovskite structure has a chemical formula selected from ABX₃ and A₂BX₆
   wherein A is a cation, B is a cation and X is an anion; and
   wherein the thermoplastic resin comprises an alkylene monomer and a monomer having acidic side groups.

There is provided a method of producing a liquid electrophotographic ink composition, comprising a dispersion of a salt AX and a thermoplastic resin in a carrier liquid, the method comprising combining a salt AX, a thermoplastic resin and a carrier liquid; wherein A is a cation and X is an anion; and wherein the thermoplastic resin comprises a copolymer of an alkylene monomer and a monomer having acidic side groups; and/or a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof.

There is provided a method of producing a liquid electrophotographic ink composition, comprising a dispersion of a salt AX and a thermoplastic resin in a carrier liquid, the method comprising combining a salt AX, a thermoplastic resin and a carrier liquid; wherein A is a cation and X is an anion; and wherein the thermoplastic resin comprises an alkylene monomer and a monomer having acidic side groups.

There is provided a method of producing a liquid electrophotographic ink composition comprising a dispersion of a salt BX₂ and a thermoplastic resin in a carrier liquid, the method comprising combining a salt BX₂ and a thermoplastic resin in a carrier liquid, wherein B is a cation and X is an anion; and wherein the thermoplastic resin comprises a copolymer of an alkylene monomer and a monomer having acidic side groups; and/or a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof.

There is provided a method of producing a liquid electrophotographic ink composition comprising a dispersion of a salt BX₂ and a thermoplastic resin in a carrier liquid, the method comprising combining a salt BX₂ and a thermoplastic resin in a carrier liquid, wherein B is a cation and X is an anion; and wherein the thermoplastic resin comprises an alkylene monomer and a monomer having acidic side groups.

There is provided a method of producing a liquid electrophotographic ink composition comprising a dispersion of a salt BX₄ and a thermoplastic resin in a carrier liquid, the method comprising combining a salt BX₄ and a thermoplastic resin in a carrier liquid, wherein B is a cation and X is an anion; and wherein the thermoplastic resin comprises a copolymer of an alkylene monomer and a monomer having acidic side groups; and/or a copolymer of an alkylene monomer, an ethylenically unsaturated monomer comprising an epoxide, and a monomer selected from a monomer having acidic side groups, a monomer having ester side groups and a mixture thereof.

There is provided a method of producing a liquid electrophotographic ink composition comprising a dispersion of a salt BX₄ and a thermoplastic resin in a carrier liquid, the method comprising combining a salt BX₄ and a thermoplastic resin in a carrier liquid, wherein B is a cation and X is an anion; and wherein the thermoplastic resin comprises an alkylene monomer and a monomer having acidic side groups.

There is provided a method of producing a liquid electrophotographic ink composition comprising a material with a perovskite structure and a thermoplastic resin in a carrier liquid, the method comprising:
combining a salt AX, a salt selected from BX₂ and BX₄, and a thermoplastic resin in a carrier liquid;
or
combining a composition (for example, a liquid electrophotographic ink composition) comprising a dispersion of a salt AX and a thermoplastic resin in a carrier liquid with a composition (for example, a liquid electrophotographic ink composition) comprising a dispersion of a salt selected from BX₂ and BX₄ and a thermoplastic resin in a carrier liquid.

The class of materials known as perovskites (i.e., materials with a perovskite crystal structure and a chemical formula ABX₃ or A₂BX₆) have been found to be particularly effective for use in photovoltaic cells and as semiconductor components in other electronic devices. Currently, many perovskites deteriorate on exposure to water and oxygen. Moreover, many current methods of forming perovskites on a substrate involve synthesis of the perovskite in solvents such as dimethylformamide (DMF) and dimethyl sulfoxide (DMSO), which are flammable and harmful to the environment.

Examples of the ink, printed substrate and method of producing a material with a perovskite structure described herein have been found to avoid or at least mitigate at least one of these difficulties. It has been found that perovskites disclosed herein can be prepared in a carrier liquid. Furthermore, it has been found that liquid electrophotographic printing can be used to form materials with a perovskite structure on substrates. Additionally, the printed substrates produced have been found to be more stable. In particular, it has been found that by using a copolymer comprising an epoxide as the thermoplastic resin the stability of the printed substrates is further increased, allowing the printed substrate to be exposed to air for at least one month without requiring additional protective layers.

Ink Set

In an aspect, there is provided an ink set. The ink set may comprise a liquid electrophotographic ink composition comprising a dispersion of a material with a perovskite structure and a thermoplastic resin in a carrier liquid; or a liquid electrophotographic ink composition comprising a dispersion of a salt AX and a thermoplastic resin in a carrier liquid and a liquid electrophotographic ink composition comprising a dispersion of a salt BX₂ or a salt BX₄ and a thermoplastic resin in a carrier liquid.

In some examples, the material with a perovskite structure is selected from materials with the chemical formula ABX₃ and materials with the chemical formula A₂BX₆.

In some examples, A and B are each independently a cation and X is an anion. In some examples, the material with a perovskite structure has the chemical formula ABX₃, wherein A is a monovalent cation, B is a divalent cation and X is a monovalent anion. In some examples, the material with a perovskite structure has the chemical formula A₂BX₆, wherein A is a monovalent cation, B is a tetravalent cation and X is a monovalent anion. In some examples, the material with a perovskite structure has the chemical formula A₂BX₆, wherein A is a monovalent cation, B is a mixture of two divalent cations and X is a monovalent anion.

In some examples, the thermoplastic resin comprises a copolymer of an alkylene monomer and a monomer having acidic side groups; and/or a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof. In some examples, the thermoplastic resin comprises a copolymer of an alkylene monomer and a monomer having acidic side groups. In some examples, the thermoplastic resin comprises a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof. In some examples, the thermoplastic resin comprises a copolymer of an alkylene monomer and an ethylenically unsaturated monomer comprising an epoxide.

In some examples, the a copolymer of an alkylene monomer, an ethylenically unsaturated monomer comprising an epoxide, and a monomer selected from a monomer having acidic side groups, a monomer having ester side groups and a mixture thereof is a copolymer of a copolymer of an alkylene monomer, an ethylenically unsaturated monomer comprising an epoxide, and a monomer having acidic side groups. In some examples, the copolymer of an alkylene monomer, an ethylenically unsaturated monomer comprising an epoxide, and a monomer having ester side groups. In some examples, the copolymer of an alkylene monomer, an ethylenically unsaturated monomer comprising an epoxide, a monomer having acidic side groups and a monomer having ester side groups.

In some examples, the ink set may comprise a liquid electrophotographic ink composition comprising a dispersion of a material with a perovskite structure and a thermoplastic resin in a carrier liquid, wherein the material with a perovskite structure has a chemical formula selected from ABX₃ and A₂BX₆.

In some examples, the ink set may comprise a liquid electrophotographic ink composition comprising a dispersion of a salt AX and a thermoplastic resin in a carrier liquid; and a liquid electrophotographic ink composition comprising a dispersion of a salt BX₂ or a salt BX₄ and a thermoplastic resin in a carrier liquid. In some examples, the ink set may comprise a liquid electrophotographic ink composition comprising a dispersion of a salt AX and a thermoplastic resin in a carrier liquid; and a liquid electrophotographic ink composition comprising a dispersion of a salt BX₂ and a thermoplastic resin in a carrier liquid. In some examples, the ink set may comprise a liquid electrophotographic ink composition comprising a dispersion of a salt AX and a thermoplastic resin in a carrier liquid; and a liquid electrophotographic ink composition comprising a dispersion of a salt BX₄ and a thermoplastic resin in a carrier liquid.

In some examples, the thermoplastic resin of each liquid electrophotographic ink composition in the ink set may be the same or different. In some examples, the thermoplastic resin of each liquid electrophotographic ink composition in the ink set may be the same.

In some examples, the carrier liquid of each liquid electrophotographic ink composition in the ink set may be the same or different. In some examples, the carrier liquid of each liquid electrophotographic ink composition in the ink set may be the same.

In some examples, the ink set may comprise a liquid electrophotographic ink composition comprising a dispersion of a salt AX and a thermoplastic resin in a carrier liquid; and a liquid electrophotographic ink composition comprising a dispersion of a salt BX₂ and a thermoplastic resin in a carrier liquid, wherein the two liquid electrophotographic ink compositions are present in amounts such that the ratio of salt AX to salt BX₂ is about 1:1 (by number of moles). In some examples, the ink set may comprise a liquid electrophotographic ink composition comprising a dispersion of a salt AX and a thermoplastic resin in a carrier liquid; and a liquid electrophotographic ink composition comprising a dispersion of a salt BX₄ and a thermoplastic resin in a carrier liquid, wherein the two liquid electrophotographic ink compositions are present in amounts such that the ratio of salt AX to salt BX₄ is about 2:1 (by number of moles).

Liquid Electrophotographic Ink Comprising AX

In some examples, the ink set comprises a liquid electrophotographic ink composition comprising a dispersion of a salt AX and a thermoplastic resin in a carrier liquid.

In some examples, the liquid electrophotographic ink composition comprising a dispersion of a salt AX and a thermoplastic resin in a carrier liquid may comprise a carrier liquid and chargeable particles comprising a salt AX and a thermoplastic resin.

In some examples, the liquid electrophotographic ink composition comprising a dispersion of a salt AX and a thermoplastic resin in a carrier liquid may further comprise a charge adjuvant.

In some examples, the liquid electrophotographic ink composition comprising a dispersion of a salt AX and a thermoplastic resin in a carrier liquid may further comprise a charge director. In some examples, the liquid electrophotographic ink composition comprising a dispersion of a salt AX and a thermoplastic resin in a carrier liquid may further comprise a charge adjuvant and a charge director.

In some examples, the liquid electrophotographic ink composition comprising a dispersion of a salt AX and a thermoplastic resin in a carrier liquid may further comprise additives.

In some examples, the thermoplastic resin may constitute 5 wt. % or more of the total non-volatile solids of the liquid electrophotographic ink composition comprising a dispersion of a salt AX and a thermoplastic resin in a carrier liquid, for example, 10 wt. % or more, 15 wt. % or more, 20 wt. % or more, 25 wt. % or more, 30 wt. % or more, 35 wt. % or more, 40 wt. % or more, 45 wt. % or more, 50 wt. % or more, 55 wt. % or more, 60 wt. % or more, 65 wt. % or more, 70 wt. % or more, or 75 wt. % or more of the total non-volatile solids of the liquid electrophotographic ink composition comprising a dispersion of a salt AX and a thermoplastic resin in a carrier liquid. In some examples, the thermoplastic resin may constitute 75 wt. % or less of the total solids of the liquid electrophotographic ink composition comprising a dispersion of a salt AX and a thermoplastic resin in a carrier liquid, for example, 70 wt. % or less, 65 wt. % or less, 60 wt. % or less, 55 wt. % or less, 50 wt. % or less, 45 wt. % or less, 40 wt. % or less, 35 wt. % or less, 30 wt. % or less, 25 wt. % or less, 20 wt. % or less, 15 wt. % or less, 10 wt. % or less, 5 wt. % or less of the total solids of the liquid electrophotographic ink composition comprising a dispersion of a salt AX and a thermoplastic resin in a carrier liquid. In some examples, the thermoplastic resin may constitute 5 wt. % to 75 wt. % of the total non-volatile solids of the liquid electrophotographic ink composition comprising a dispersion of a salt AX and a thermoplastic resin in a carrier liquid, for example, 10 wt. % to 70 wt. %, 15 wt. % to 65 wt. %, 20 wt. % to 60 wt. %, 25 wt. % to 55 wt. %, 30 wt. % to 50 wt. %, 35 wt. % to 70 wt. %, 40 wt. % to 50 wt. %, or 45 wt. % to 60 wt. % of the total non-volatile solids of the liquid electrophotographic ink composition comprising a dispersion of a salt AX and a thermoplastic resin in a carrier liquid. In some examples, the thermoplastic resin may comprise about 46 wt. % of the total non-volatile solids of the liquid electrophotographic ink composition comprising a dispersion of a salt AX and a thermoplastic resin in a carrier liquid.

In some examples, the salt AX may constitute 25 wt. % or more of the total solids of the liquid electrophotographic ink composition comprising a dispersion of a salt AX and a thermoplastic resin in a carrier liquid, for example, 30 wt. % or more, 35 wt. % or more, 40 wt. % or more, 45 wt. % or more, 50 wt. % or more, 55 wt. % or more, 60 wt. % or more, 65 wt. % or more, 70 wt. % or more, 75 wt. % or more, 80 wt. % or more, 85 wt. % or more, 90 wt. % or more, or 95 wt. % or more of the total solids of the liquid electrophotographic ink composition comprising a dispersion of a salt AX and a thermoplastic resin in a carrier liquid. In some examples, the salt AX may constitute 95 wt. % or less of the total solids of the liquid electrophotographic ink composition comprising a dispersion of a salt AX and a thermoplastic resin in a carrier liquid, for example, 90 wt. % or less, 85 wt. % or less, 80 wt. % or less, 75 wt. % or less, 70 wt. % or less, 65 wt. % or less, 60 wt. % or less, 55 wt. % or less, 50 wt. % or less, 45 wt. % or less, 40 wt. % or less, 35 wt. % or less, 30 wt. % or less, or 25 wt. % or less of the total solids of the liquid electrophotographic ink composition comprising a dispersion of a salt AX and a thermoplastic resin in a carrier liquid. In some examples, the salt AX may constitute 25 wt. % to 95 wt. % of the total solids of the liquid electrophotographic ink composition comprising a dispersion of a salt AX and a thermoplastic resin in a carrier liquid, for example, 30 wt. % to 90 wt. %, 35 wt. % to 85 wt. %, 40 wt. % to 80 wt. %, 45 wt. % to 75 wt. %, 50 wt. % to 70 wt. %, 35 wt. % to 65 wt. %, 45 wt. % to 60 wt. %, or 50 wt. % to 55 wt. % of the total solids of the liquid electrophotographic ink composition comprising a dispersion of a salt AX and a thermoplastic resin in a carrier liquid. In some examples, the salt AX may comprise about 50 wt. % of the total non-volatile solids of the liquid electrophotographic ink composition comprising a dispersion of a salt AX and a thermoplastic resin in a carrier liquid.

Liquid Electrophotographic Ink Composition Comprising BX₂

In some examples, the ink set comprises a liquid electrophotographic ink composition comprising a dispersion of a salt BX₂ and a thermoplastic resin in a carrier liquid.

In some examples, the liquid electrophotographic ink composition comprising a dispersion of a salt BX₂ and a thermoplastic resin in a carrier liquid may comprise a carrier liquid and chargeable particles comprising a salt BX₂ and a thermoplastic resin.

In some examples, the liquid electrophotographic ink composition comprising a dispersion of a salt BX₂ and a thermoplastic resin in a carrier liquid may further comprise a charge adjuvant.

In some examples, the liquid electrophotographic ink composition comprising a dispersion of a salt BX₂ and a thermoplastic resin in a carrier liquid may further comprise a charge director. In some examples, the liquid electrophotographic ink composition comprising a dispersion of a salt BX₂ and a thermoplastic resin in a carrier liquid may further comprise a charge adjuvant and a charge director.

In some examples, the liquid electrophotographic ink composition comprising a dispersion of a salt BX₂ and a thermoplastic resin in a carrier liquid may further comprise additives.

In some examples, the thermoplastic resin in the liquid electrophotographic ink composition comprising a dispersion of a salt BX₂ and a thermoplastic resin in a carrier liquid may be the same as or different from the thermoplastic resin in the liquid electrophotographic ink composition comprising a dispersion of a salt AX and a thermoplastic resin in a carrier liquid. In some examples, the thermoplastic resin in the liquid electrophotographic ink composition comprising a dispersion of a salt BX₂ and a thermoplastic resin in a carrier liquid may be the same as the thermoplastic resin in the liquid electrophotographic ink composition comprising a dispersion of a salt AX and a thermoplastic resin in a carrier liquid.

In some examples, the thermoplastic resin may constitute 5 wt. % or more of the total non-volatile solids of the liquid electrophotographic ink composition comprising a dispersion of a salt BX₂ and a thermoplastic resin in a carrier liquid, for example, 10 wt. % or more, 15 wt. % or more, 20 wt. % or more, 25 wt. % or more, 30 wt. % or more, 35 wt. % or more, 40 wt. % or more, 45 wt. % or more, 50 wt. % or more, 55 wt. % or more, 60 wt. % or more, or 65 wt. % or more of the total non-volatile solids of the liquid electrophotographic ink composition comprising a dispersion of a salt BX₂ and a thermoplastic resin in a carrier liquid. In some examples, the thermoplastic resin may constitute 65 wt. % or less of the total solids of the liquid electrophotographic ink composition comprising a dispersion of a salt BX₂ and a thermoplastic resin in a carrier liquid, for example, 60 wt. % or less, 55 wt. % or less, 50 wt. % or less, 45 wt. % or less, 40 wt. % or less, 35 wt. % or less, 30 wt. % or less, 25 wt. % or less, 20 wt. % or less, 15 wt. % or less, 10 wt. % or less, 5 wt. % or less of the total solids of the liquid electrophotographic ink composition comprising a dispersion of a salt BX₂ and a thermoplastic resin in a carrier liquid. In some examples, the thermoplastic resin may constitute 5 wt. % to 65 wt. % of the total non-volatile solids of the liquid electrophotographic ink composition comprising a dispersion of a salt BX₂ and a thermoplastic resin in a carrier liquid, for example, 10 wt. % to 60 wt. %, 15 wt. % to 55 wt. %, 20 wt. % to 50 wt. %, 25 wt. % to 45 wt. %, 30 wt. % to 40 wt. %, or 35 wt. % to 40 wt. % of the total non-volatile solids of the liquid electrophotographic ink composition comprising a dispersion of a salt BX₂ and a thermoplastic resin in a carrier liquid. In some examples, the thermoplastic resin may comprise about 36 wt. % of the total non-volatile solids of the liquid electrophotographic ink composition comprising a dispersion of a salt BX₂ and a thermoplastic resin in a carrier liquid.

In some examples, the salt BX₂ may constitute 35 wt. % or more of the total solids of the liquid electrophotographic ink composition comprising a dispersion of a salt BX₂ and a thermoplastic resin in a carrier liquid, for example, 40 wt. % or more, 45 wt. % or more, 50 wt. % or more, 55 wt. % or more, 60 wt. % or more, 65 wt. % or more, 70 wt. % or more, 75 wt. % or more, 80 wt. % or more, 85 wt. % or more, 90 wt. % or more, 95 wt. % or more of the total solids of the liquid electrophotographic ink composition comprising a dispersion of a salt BX₂ and a thermoplastic resin in a carrier liquid. In some examples, the salt BX₂ may constitute 95 wt. % or less of the total solids of the liquid electrophotographic ink composition comprising a dispersion of a salt BX₂ and a thermoplastic resin in a carrier liquid, for example, 90 wt. % or less, 85 wt. % or less, 80 wt. % or less, 75 wt. % or less, 70 wt. % or less, 65 wt. % or less, 60 wt. % or less, 55 wt. % or less, 50 wt. % or less, 45 wt. % or less, 40 wt. % or less, 35 wt. % or less of the total solids of the liquid electrophotographic ink composition comprising a dispersion of a salt BX₂ and a thermoplastic resin in a carrier liquid. In some examples, the salt BX₂ may constitute 35 wt. % to 95 wt. % of the total solids of the liquid electrophotographic ink composition comprising a dispersion of a salt BX₂ and a thermoplastic resin in a carrier liquid, for example, 40 wt. % to 90 wt. %, 45 wt. % to 85 wt. %, 50 wt. % to 80 wt. %, 55 wt. % to 75 wt. %, 60 wt. % to 70 wt. %, or 55 wt. % to 65 wt. % of the total solids of the liquid electrophotographic ink composition comprising a dispersion of a salt BX₂ and a thermoplastic resin in a carrier liquid. In some examples, the salt BX₂ may comprise about 60 wt. % of the total non-volatile solids of the liquid electrophotographic ink composition comprising a dispersion of a salt BX₂ and a thermoplastic resin in a carrier liquid.

Liquid Electrophotographic Ink Composition Comprising a Salt BX₄

In some examples, the ink set comprises a liquid electrophotographic ink composition comprising a dispersion of a salt BX₄ and a thermoplastic resin in a carrier liquid. In some examples, the liquid electrophotographic ink composition comprising a salt BX₄ may be as described above for the liquid electrophotographic ink composition comprising a salt BX₂ except that the salt BX₄ is used instead of the salt BX₂.

Liquid Electrophotographic Ink Composition Comprising a Material with a Perovskite Structure

In some examples, the ink set comprises a liquid electrophotographic ink composition comprising a dispersion of a material with a perovskite structure and a thermoplastic resin in a carrier liquid, wherein the material with a perovskite structure has a chemical formula selected from ABX₃ and A₂BX₆. In some examples, the material with a perovskite structure has the chemical formula ABX₃. In some examples, the material with a perovskite structure has the chemical formula A₂BX₆.

In some examples, the liquid electrophotographic ink composition comprising a dispersion of a material with a perovskite structure and a thermoplastic resin in a carrier liquid may comprise a carrier liquid and chargeable particles comprising a material with a perovskite structure and a thermoplastic resin.

In some examples, the liquid electrophotographic ink composition comprising a dispersion of a material with a perovskite structure and a thermoplastic resin in a carrier liquid may be producible by combining a liquid electrophotographic ink composition comprising a dispersion of a salt AX and a thermoplastic resin in a carrier liquid with a liquid electrophotographic ink composition comprising a dispersion of a salt BX₂ or a salt BX₄ and a thermoplastic resin in a carrier liquid.

In some examples, the liquid electrophotographic ink composition comprising a dispersion of a material with a perovskite structure and a thermoplastic resin in a carrier liquid may be producible by combining a salt AX, a salt selected from BX₂ and BX₄, a thermoplastic resin and a carrier liquid. In some examples, the liquid electrophotographic ink composition comprising a dispersion of a material with a perovskite structure and a thermoplastic resin in a carrier liquid, wherein the material with a perovskite structure has the chemical formula ABX₃, may be producible by combining a salt AX, a salt BX₂, a thermoplastic resin and a carrier liquid. In some examples, the liquid electrophotographic ink composition comprising a dispersion of a material with a perovskite structure and a thermoplastic resin in a carrier liquid, wherein the material with a perovskite structure has the chemical formula A₂BX₆, may be producible by combining a salt AX, a salt BX₄, a thermoplastic resin and a carrier liquid.

In some examples, the liquid electrophotographic ink composition comprising a dispersion of a material with a perovskite structure and a thermoplastic resin in a carrier liquid may further comprise a charge adjuvant.

In some examples, the liquid electrophotographic ink composition comprising a dispersion of a material with a perovskite structure and a thermoplastic resin in a carrier liquid may further comprise a charge director. In some examples, the liquid electrophotographic ink composition comprising a dispersion of a material with a perovskite structure and a thermoplastic resin in a carrier liquid may further comprise a charge adjuvant and a charge director.

In some examples, the liquid electrophotographic ink composition comprising a dispersion of a material with a perovskite structure and a thermoplastic resin in a carrier liquid may further comprise additives.

In some examples, the thermoplastic resin may constitute 5 wt. % or more of the total non-volatile solids of the liquid electrophotographic ink composition comprising a dispersion of a material with a perovskite structure and a thermoplastic resin in a carrier liquid, for example, 10 wt. % or more, 15 wt. % or more, 20 wt. % or more, 25 wt. % or more, 30 wt. % or more, 35 wt. % or more, 40 wt. % or more, 45 wt. % or more, 50 wt. % or more, 55 wt. % or more, or 60 wt. % or more of the total non-volatile solids of the liquid electrophotographic ink composition comprising a dispersion of a material with a perovskite structure and a thermoplastic resin in a carrier liquid. In some examples, the thermoplastic resin may constitute 60 wt. % or less of the total solids of the liquid electrophotographic ink composition comprising a dispersion of a material with a perovskite structure and a thermoplastic resin in a carrier liquid, for example, 55 wt. % or less, 40 wt. % or less, 45 wt. % or less, 40 wt. % or less, 35 wt. % or less, 30 wt. % or less, 25 wt. % or less, 20 wt. % or less, 15 wt. % or less, 10 wt. % or less, or 5 wt. % or less of the total solids of the liquid electrophotographic ink composition comprising a dispersion of a material with a perovskite structure and a thermoplastic resin in a carrier liquid. In some examples, the thermoplastic resin may constitute 5 wt. % to 60 wt. % of the total non-volatile solids of the liquid electrophotographic ink composition comprising a dispersion of a material with a perovskite structure and a thermoplastic resin in a carrier liquid, for example, 10 wt. % to 55 wt. %, 15 wt. % to 50 wt. %, 20 wt. % to 45 wt. %, 25 wt. % to 45 wt. %, 30 wt. % to 60 wt. %, 35 wt. % to 55 wt. %, or 40 wt. % to 45 wt. % of the total non-volatile solids of the liquid electrophotographic ink composition comprising a dispersion of a material with a perovskite structure and a thermoplastic resin in a carrier liquid. In some examples, the thermoplastic resin may comprise about 44 wt. % of the total non-volatile solids of the liquid electrophotographic ink composition comprising a dispersion of a material with a perovskite structure and a thermoplastic resin in a carrier liquid.

In some examples, the thermoplastic resin may comprise about 54 wt. % of the total non-volatile solids of the liquid electrophotographic ink composition comprising a dispersion of a material with a perovskite structure and a thermoplastic resin in a carrier liquid. In some examples, the thermoplastic resin may comprise about 19.4 wt. % of the total non-volatile solids of the liquid electrophotographic ink composition comprising a dispersion of a material with a perovskite structure and a thermoplastic resin in a carrier liquid.

In some examples, the material with a perovskite structure may constitute 20 wt. % or more of the total solids of the liquid electrophotographic ink composition comprising a dispersion of a material with a perovskite structure and a thermoplastic resin in a carrier liquid, for example, 20 wt. % or more, 25 wt. % or more, 30 wt. % or more, 35 wt. % or more, 40 wt. % or more, 45 wt. % or more, 50 wt. % or more, 55 wt. % or more, 60 wt. % or more, 65 wt. % or more, 70 wt. % or more, 75 wt. % or more, 80 wt. % or more, 85 wt. % or more, 90 wt. % or more, or 95 wt. % or more of the total solids of the liquid electrophotographic ink composition comprising a dispersion of a material with a perovskite structure and a thermoplastic resin in a carrier liquid. In some examples, the material with a perovskite structure may constitute 95 wt. % or less of the total solids of the liquid electrophotographic ink composition comprising a dispersion of a material with a perovskite structure and a thermoplastic resin in a carrier liquid, for example, 90 wt. % or less, 85 wt. % or less, 80 wt. % or less, 75 wt. % or less, 70 wt. % or less, 65 wt. % or less, 60 wt. % or less, 55 wt. % or less, 50 wt. % or less, 45 wt. % or less, or 40 wt. % or less of the total solids of the liquid electrophotographic ink composition comprising a dispersion of a material with a perovskite structure and a thermoplastic resin in a carrier liquid. In some examples, the material with a perovskite structure may constitute 40 wt. % to 95 wt. % of the total solids of the liquid electrophotographic ink composition comprising a dispersion of a material with a perovskite structure and a thermoplastic resin in a carrier liquid, for example, 45 wt. % to 90 wt. %, 50 wt. % to 85 wt. %, 45 wt. % to 80 wt. %, 50 wt. % to 75 wt. %, 45 wt. % to 70 wt. %, 50 wt. % to 65 wt. %, or 40 wt. % to 60 wt. % of the total solids of the liquid electrophotographic ink composition comprising a dispersion of a material with a perovskite structure and a thermoplastic resin in a carrier liquid. In some examples, the material with a perovskite structure may comprise about 52 wt. % of the total non-volatile solids of the liquid electrophotographic ink composition comprising a dispersion of a material with a perovskite structure and a thermoplastic resin in a carrier liquid.

Salt AX

In some examples, the salt AX may be a salt of a cation and an anion. In some examples, the salt AX may be a salt of a monovalent cation and a monovalent anion. In some examples, the salt AX may be a salt of a divalent cation and a divalent anion. In some examples, the salt AX may be a mixture of salts comprising monovalent cations and monovalent anions. In some examples, A is a monovalent cation or a mixture of monovalent cations. In some examples, X is a monovalent anion or a mixture of monovalent anions.

In some examples, A is selected from a metal cation, an organic cation or a mixture thereof. In some examples, A is selected from a monovalent metal cation, a monovalent organic cation, or a mixture thereof. In some examples, A is a monovalent metal cation or a mixture thereof. In some examples, A is a monovalent organic cation or a mixture thereof. In some examples, A is a mixture of a monovalent metal cation and a monovalent organic cation.

In some examples, A is an organic cation selected from primary aliphatic ammonium cations and primary aromatic ammonium cations. In some examples, A is selected from methylammonium (MA), formamidinium (FA), rubidium (Rb), caesium (Cs), and mixtures thereof. In some examples, A is caesium (Cs).

In some examples, X is a monovalent anion or a mixture of monovalent anions. In some examples, X is a halide ion. In some examples, X is selected from iodide, bromide, chloride and mixtures thereof. In some examples, X is selected from iodide, bromide and chloride. In some examples, X is bromide.

In some examples, AX may be selected from methylammonium iodide (MAI), methylammonium bromide (MABr), methylammonium chloride (MACI) formamidinium iodide (FAI), formamidinium bromide (FABr), formamidinium chloride (FABr), caesium iodide (CsI), caesium bromide (CsBr), caesium chloride (CsCl) rubidium iodide (Rbl), rubidium bromide (RbBr), rubidium chloride (RbCI) or mixtures thereof. In some examples, AX may be selected from methylammonium iodide (MAI), methylammonium bromide (MABr), formamidinium iodide (FAI), formamidinium bromide (FABr), caesium iodide (CsI), caesium bromide (CsBr), or mixtures thereof. In some examples, AX may be selected from methylammonium iodide (MAI), methylammonium bromide (MABr), formamidinium iodide (FAI), formamidinium bromide (FABr), caesium iodide (CsI) and caesium bromide (CsBr). In some examples, AX may be selected from CsI and CsBr. In some examples, AX may be CsBr.

Salt BX₂

In some examples, the salt BX₂ may be a salt of a cation and an anion. In some examples, the salt BX₂ may be a salt of a divalent cation and a monovalent anion. In some examples, the salt BX₂ may be a salt of a tetravalent cation and a divalent anion.

In some examples, the salt BX₂ may be a mixture of salts comprising divalent cations and monovalent anions. In some examples, B is a divalent cation or a mixture of divalent cations. In some examples, X is a monovalent anion or a mixture of monovalent anions. In some examples, X in BX₂ may be different from X in AX. In some examples, X in BX₂ may be the same as X in AX.

In some examples, B is a divalent metal cation or a mixture of divalent metal cations. In some examples, B is a divalent metal cation.

In some examples, B is selected from lead (Pb), germanium (Ge), tin (Sn), antimony (Sb), bismuth (Bi), copper (Cu), manganese (Mn²+), cobalt (Co²+) and mixtures thereof. In some examples, B is selected from lead (Pb), germanium (Ge), tin (Sn), antimony (Sb), bismuth (Bi), Copper (Cu) and mixtures thereof.

In some examples, X is as described above for AX.

In some examples, BX₂ may be selected from SnI₂, SnBr₂, SnCl₂, PbI₂, PbBr₂, PbCl₂ and combinations thereof. In some examples, BX₂ may be selected from SnI₂, SnBr₂, PbI₂, PbBr₂ and combinations thereof. In some examples, BX₂ may be selected from SnI₂, SnBr₂, PbI₂ and PbBr₂. In some examples, BX₂ may be selected from SnI₂ and SnBr₂. In some examples, BX₂ may be SnBr₂.

Salt BX₄

In some examples, the salt BX₄ may be a salt of a cation and an anion. In some examples, the salt BX₄ may be a salt of a tetravalent cation and a monovalent anion. In some examples, the salt BX₄ may be a mixture of salts comprising tetravalent cations and monovalent anions. In some examples, B is a tetravalent cation or a mixture of tetravalent cations. In some examples, X is a monovalent anion or a mixture of monovalent anions. In some examples, X in BX₂ may be the same as X in AX.

In some examples, B is a tetravalent metal cation or a mixture of tetravalent metal cations. In some examples, B is a tetravalent metal cation. In some examples, B is Sn⁴⁺.

In some examples, BX₄ is selected from SnI₄, SnBr₄, SnCl₄ and combinations thereof.

Material with a Perovskite Structure

In some examples, the material with a perovskite structure may be a perovskite wherein A is a cation or a mixture of cations, B is a cation or a mixture of cations and X is an anion or a mixture of anions. In some examples, the material with a perovskite structure may have the chemical formula ABX₃ wherein A is a monovalent cation or a mixture of monovalent cations, B is a divalent cation or a mixture of divalent cations and X is a monovalent anion or a mixture of monovalent anions. In some examples, the material with a perovskite structure may have the chemical formula ABX₃ wherein A is a divalent cation or a mixture of divalent cations, B is a tetravalent cation or a mixture of tetravalent cations and X is a divalent anion or a mixture of divalent anions. In some examples, the material with a perovskite structure may have the chemical formula A₂BX₆ wherein A is a monovalent cation or a mixture of monovalent cations, B is a tetravalent cation or mixture of tetravalent cations and X is a monovalent anion or a mixture of monovalent anions. In some examples, the material with a perovskite structure may have the chemical formula ABX₃ wherein A is a monovalent cation, B is a divalent cation and X is a monovalent anion or a mixture of monovalent anions. In some examples, the material with a perovskite structure may have the chemical formula ABX₃ wherein A is a monovalent cation, B is a divalent cation and X is a monovalent anion.

In some examples, A is as described above for AX. In some examples, B is as described above for BX₂ or as described above for BX₄. In some examples, X is as described above for AX or BX₂ or BX₄.

As used herein, the term perovskite does not specifically refer to the perovskite mineral, CaTiO₃ but instead refers to any material that has the same type of crystal structure as calcium titanium oxide. As used herein, the term perovskite structure indicates that the material has the perovskite type crystal structure.

In some examples, the material with a perovskite structure may be selected from CsSnBr₃, Cs₂SnBr₆, Rb_{z}[Cs_{y}(MAₓFA₁₋ₓ)₁-y]_{1-z}Pb₁M₁₋₁(I₁₋ₙ₋ₘBrₘClₙ)₃ wherein 0≤x≤1, 0≤y≤1, 0≤z≤1, 0≤I≤1, 0·m≤1, 0≤n≤1; M=Sn or In), and Rb_{z}[Cs_{y}(MAₓFA₁₋ₓ)_{1-y}]_{1-z}B(I₁₋ₙ₋ₘBrₘClₙ)₃ (wherein 0≤x≤1, 0≤y≤1, 0≤z≤1, 0≤m≤1, 0≤n≤1; B=Ge, Sn, Sb, Bi or Cu). In some examples, the material with a perovskite structure may be CsSnBr₃.

Thermoplastic Resin

In some examples, the thermoplastic resin comprises a copolymer of an alkylene monomer and a monomer having acidic side groups; and/or a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof. In some examples, the thermoplastic resin comprises a copolymer of an alkylene monomer and a monomer having acidic side groups; and/or a copolymer of an alkylene monomer and an ethylenically unsaturated monomer comprising an epoxide. In some examples, the thermoplastic resin comprises a copolymer of an alkylene monomer and a monomer having acidic side groups and a copolymer of an alkylene monomer and an ethylenically unsaturated monomer comprising an epoxide. In some examples, the thermoplastic resin comprises a copolymer of an alkylene monomer and a monomer having acidic side groups or a copolymer of an alkylene monomer and an ethylenically unsaturated monomer comprising an epoxide.

In some examples, the thermoplastic resin may comprise a copolymer of an alkylene monomer and a monomer having acidic side groups. In some examples, the alkylene monomer may be selected from ethylene and propylene. In some examples, the alkylene monomer may be ethylene. In some examples, the monomer having acidic side groups may be selected from acrylic acid and methacrylic acid.

In some examples, the thermoplastic resin comprises a copolymer of ethylene and a monomer selected from acrylic acid and methacrylic acid.

The thermoplastic resin may be referred to herein as a resin.

In some examples, the liquid electrophotographic ink composition comprises chargeable particles (i.e., having or capable of developing a charge, for example, in an electromagnetic field) including the thermoplastic resin. In some examples, the chargeable particles may comprise the salt AX, the salt BX₂, the salt BX₄ or the material with a perovskite structure.

In some examples, the thermoplastic resin may comprise a polymer selected from ethylene acrylic acid copolymers; ethylene methacrylic acid copolymers; ethylene vinyl acetate copolymers; copolymers of ethylene (e.g. 80 wt. % to 99.9 wt. %), and alkyl (e.g. C1 to C5) ester of methacrylic or acrylic acid (e.g. 0.1 wt. % to 20 wt. %); copolymers of ethylene (e.g. 80 wt. % to 99.9 wt. %), acrylic or methacrylic acid (e.g. 0.1 wt. % to 20 wt. %) and alkyl (e.g. C1 to C5) ester of methacrylic or acrylic acid (e.g. 0.1 wt. % to 20 wt. %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt. % to 90 wt. %)/methacrylic acid (e.g. 0 wt. % to 20 wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers and combinations thereof.

The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg

KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g, can be measured using standard procedures known in the art, for example, using the procedure described in ASTM D1386.

The thermoplastic resin may comprise a polymer having acidic side groups that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example, as described in ASTM D1238.

The thermoplastic resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the thermoplastic resin may comprise a copolymer of an alkylene monomer and a monomer selected from methacrylic acid and acrylic acid. In some examples, the thermoplastic resin may comprise a copolymer of ethylene and a monomer selected from methacrylic acid and acrylic acid.

In some examples, the polymer having acidic side groups is a copolymer of an alkylene monomer and a monomer selected from acrylic acid and methacrylic acid. In some examples, the thermoplastic resin may comprise a copolymer of an alkylene monomer and a monomer selected from acrylic acid and methacrylic acid.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt. % to about 25 wt. % of the copolymer, in some examples from 10 wt. % to about 20 wt. % of the copolymer.

The thermoplastic resin may comprise two different polymers having acidic side groups. The two polymers having acidic side groups may have different acidities, which may fall within the ranges mentioned above. The thermoplastic resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise a copolymer of ethylene and acrylic acid and a copolymer of ethylene and methacrylic acid.

The resin may comprise two different polymers having acidic side groups: a first polymer that is a copolymer of ethylene (e.g. 92 to 85 wt. %, in some examples about 89 wt. %) and acrylic or methacrylic acid (e.g. 8 to 15 wt. %, in some examples about 11 wt. %) having a melt flow rate of 80 to 110 g/10 minutes and a second polymer that is a copolymer of ethylene (e.g. about 80 to 92 wt. %, in some examples about 85 wt. %) and acrylic acid (e.g. about 18 to 12 wt. %, in some examples about 15 wt. %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), an example of the second polymer is Nucrel 699 (from DuPont), and an example of the third polymer is AC-5120 (from Honeywell). In some examples, the resin may comprise a first polymer having a melt viscosity of from 15000 poise to 40000 poise, in some examples 20000 poise to 30000 poise, and a second polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 699 (from DuPont), and an example of the second polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers.

The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the copolymer, in some examples 10 wt. % to 16 wt. % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the copolymer, in some examples from 14 wt. % to about 20 wt. % of the copolymer, in some examples from 16 wt. % to about 20 wt. % of the copolymer in some examples from 17 wt. % to 19 wt. % of the copolymer.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40% by weight of the total solids of the electrostatic ink composition. In another example, the resin constitutes about 60 to 95% by weight, in some examples, from 65 to 90% by weight, from 65 to 80% by weight of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the copolymer, in some examples 5 to 40% by weight, in some examples 5 to 20% by weight of the copolymer, in some examples 5 to 15% by weight of the copolymer. The second monomer may constitute 1 to 50% by weight of the copolymer, in some examples 5 to 40% by weight of the copolymer, in some examples 5 to 20% by weight of the copolymer, in some examples 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In an example, the first monomer constitutes 5 to 15% by weight of the copolymer, the second monomer constitutes 5 to 15% by weight of the copolymer, with the third monomer constituting the remaining weight of the copolymer. In an example, the first monomer constitutes 8 to 12% by weight of the copolymer, the second monomer constitutes 8 to 12% by weight of the copolymer, with the third monomer constituting the remaining weight of the copolymer. In an example, the first monomer constitutes about 10% by weight of the copolymer, the second monomer constitutes about 10% by weight of the copolymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In some examples, the thermoplastic resin may comprise a copolymer of an alkylene monomer and an ethylenically unsaturated monomer comprising an epoxide.

In some examples, the ethylenically unsaturated monomer comprising an epoxide is any monomer comprising a carbon-carbon double bond and an epoxide. As used herein, the term “ethylenically unsaturated monomer” is used to indicate the presence of one carbon-carbon double bond in the monomer, which reacts during the polymerisation reaction to form the copolymer, thus forming a carbon-carbon single bond in the copolymer.

In some examples, the ethylenically unsaturated monomer comprising an epoxide is an ethylenically unsaturated ketone comprising an epoxide, an ethylenically unsaturated amide comprising an epoxide, an ethylenically unsaturated thioester comprising an epoxide, an ethylenically unsaturated ester comprising an epoxide, or a combination thereof. In some examples, the ethylenically unsaturated monomer comprising an epoxide is an ethylenically unsaturated ester comprising an epoxide. In some examples, the ethylenically unsaturated amide comprising an epoxide may be an amide of an ethylenically unsaturated carboxylic acid and an epoxide-containing amine, for example, an epoxide-containing primary amine or an epoxide-containing secondary amine. In some examples, the ethylenically unsaturated thioester comprising an epoxide may be a thioester of an ethylenically unsaturated carboxylic acid and an epoxide-containing thiol. In some examples, the ethylenically unsaturated ester comprising an epoxide may be an ester of an ethylenically unsaturated carboxylic acid and an epoxide-containing alcohol.

In some examples, the ethylenically unsaturated carboxylic acid may be any compound containing a carboxylic acid and a single carbon-carbon double bond. In some examples, the ethylenically unsaturated carboxylic acid comprises an α,β-unsaturated carboxylic acid or an α,β-unsaturated, α-alkyl carboxylic acid. In some examples, the α,β-unsaturated, α-alkyl carboxylic acid may be further substituted.

In some examples, the α,β-unsaturated carboxylic acid comprise a C1 to C10 α,β-unsaturated carboxylic acid, for example, a C1 to C6 α,β-unsaturated carboxylic acid. In some examples, the α,β-unsaturated carboxylic acid is selected from the group consisting of pent-2-enoic acid, butan-2-enoic acid and prop-2-enoic acid. In some examples, the α,β-unsaturated carboxylic acid is prop-2-enoic acid.

In some examples, the α,β-unsaturated, α-alkyl carboxylic acid comprises an α-alkyl substituted C1 to C10 α,β-unsaturated carboxylic acid, for example, an α-alkyl substituted C1 to C6 α,β-unsaturated carboxylic acid. In some examples, the α,β-unsaturated, α-alkyl carboxylic acid is selected from the group consisting of a 2-alkylpent-2-enoic acid, 2-alkylbutan-2-enoic acid and a 2-alkylprop-2-enoic acid. In some examples, the α,β-unsaturated, α-alkyl carboxylic acid is a 2-alkylprop-2-enoic acid.

In some examples, the α-alkyl group of the α,β-unsaturated, α-alkyl carboxylic acid is a substituted or unsubstituted alkyl group. In some examples, the α-alkyl substituent of the α,β-unsaturated, α-alkyl carboxylic acid (for example, the 2-alkyl substituent of 2-alkylprop-2-enoic acid) is a C1 to C10 alkyl group, for example, a C1 to C6 alkyl, such as methyl, ethyl, propyl (e.g., n-propyl or isopropyl), or butyl (e.g., n-butyl, sec-butyl, isobutyl or tert-butyl). In some examples, the α-alkyl substituent of the α,β-unsaturated, α-alkyl carboxylic acid (for example, the 2-alkyl substituent of 2-alkylprop-2-enoic acid) is selected the group consisting of methyl, ethyl and propyl. In some examples, the α-alkyl substituent of the α,β-unsaturated, α-alkyl carboxylic acid is methyl.

In some examples, the ethylenically unsaturated carboxylic acid is selected from 2-propylprop-2-enoic acid, 2-ethylprop-2-enoic acid and 2-methylprop-2-enoic acid. In some examples, the ethylenically unsaturated carboxylic acid is 2-methylprop-2-enoic acid, which is also known as methacrylic acid.

In some examples, the epoxide-containing alcohol may be any compound containing an epoxide group and an alcohol group. In some examples, the epoxide-containing alcohol may be any alkane containing an epoxide group and an alcohol.

In some examples, the epoxide-containing alcohol comprises a primary alcohol, a secondary alcohol or a tertiary alcohol. In some examples, the epoxide-containing alcohol comprises a primary alcohol.

In some examples, the epoxide-containing alcohol may comprise a mono-substituted epoxide (also referred to herein as a terminal epoxide), a di-substituted epoxide, a tri-substituted epoxide or a tetra-substituted epoxide. In some examples, the epoxide-containing alcohol may comprise a mono-substituted or a di-substituted epoxide. In some examples, the epoxide-containing alcohol may comprise a terminal epoxide. In some examples, the di-substituted epoxide may have the formula —CR(O)CH₂. A terminal epoxide is an epoxide having the formula —CH(O)CH₂.

In some examples, the epoxide-containing alcohol may comprise a primary alcohol and a terminal epoxide.

In some examples, the epoxide-containing alcohol may be any epoxide-containing alcohol. In some examples, the epoxide-containing alcohol may comprise 2 to 30 carbon atoms, for example, 3 to 25 carbon atoms, 3 to 20 carbon atoms, 3 to 15 carbon atoms, 3 to 10 carbon atoms, 3 to 5 carbon atoms, 3 to 4 carbon atoms. In some examples, the epoxide-containing alcohol may be selected from glycidol (i.e., 2,3-epoxy-1-propanol), epoxybutanol (e.g., 3,4-epoxy-1-butanol), and epoxypentanol (e.g., 4,5-epoxy-1-pentanol). In some examples, the epoxide-containing alcohol may be glycidol.

In some examples, the ethylenically unsaturated ester comprising an epoxide may be selected from glycidyl methacrylate, glycidyl 2-ethylprop-2-enoate, glycidyl 2-propylprop-2-enoate, epoxybutanyl methacrylate, epoxybutanyl 2-ethylprop-2-enoate, epoxybutanyl 2-propylprop-2-enoate, epoxypentanyl methacrylate, epoxypentanyl 2-ethylprop-2-enoate, epoxypentanyl 2-propylprop-2-enoate. In some examples, the ethylenically unsaturated ester comprising an epoxide is glycidyl methacrylate.

In some examples, the copolymer of an alkylene monomer and an ethylenically unsaturated monomer comprising an epoxide may be a copolymer of ethylene and an ethylenically unsaturated ester comprising an epoxide, such as glycidyl methacrylate.

In some examples, the ethylenically unsaturated monomer comprising an epoxide constitutes at least 1 wt. % of the copolymer of an alkylene monomer and an ethylenically unsaturated monomer comprising an epoxide, for example, at least 1.5 wt. %, at least 2 wt. %, at least 2.5 wt. %, at least 3 wt. %, at least 3.5 wt. %, at least 4 wt. %, at least 4.5 wt. %, at least 5 wt. %, at least 5.5 wt. %, at least 6 wt. %, at least 6.5 wt. % of the copolymer of an alkylene monomer and an ethylenically unsaturated monomer comprising an epoxide.

In some examples, the ethylenically unsaturated monomer comprising an epoxide constitutes 50 wt. % or less of the copolymer of an alkylene monomer and an ethylenically unsaturated monomer comprising an epoxide, for example, 25 wt. % or less, 20 wt. % or less, 15 wt. % or less, 14 wt. % or less, 13 wt. % or less, 12 wt. % or less, 11 wt. % or less, 10.5 wt. % or less, 10 wt. % or less, 9.5 wt. % or less, 9 wt. % or less of the copolymer of an alkylene monomer and an ethylenically unsaturated monomer comprising an epoxide.

In some examples, the ethylenically unsaturated monomer comprising an epoxide constitutes from about 1 wt. % to about 50 wt. % of the copolymer of an alkylene monomer and an ethylenically unsaturated monomer comprising an epoxide, for example, from about 1.5 wt. % to about 25 wt. %, from about 2 wt. % to about 20 wt. %, from about 2.5 wt. % to about 15 wt. %, from about 3 wt. % to about 14 wt. %, from about 3.5 wt. % to about 13 wt. %, from about 4 wt. % to about 12 wt. %, from about 4.5 wt. % to about 11 wt. %, from about 5 wt. % to about 10.5 wt. %, from about 5.5 wt. % to about 10 wt. %, from about 6 wt. % to about 9.5 wt. %, from about 6.5 wt. % to about 9 wt. % of the copolymer of an alkylene monomer and an ethylenically unsaturated monomer comprising an epoxide. In some examples, the alkylene monomer may constitute the remaining weight percent of the copolymer of an alkylene monomer and an ethylenically unsaturated monomer comprising an epoxide.

In some examples, the thermoplastic resin may comprise a copolymer of an alkylene monomer, an ethylenically unsaturated monomer comprising an epoxide, and a monomer selected from a monomer having acidic side groups, a monomer having ester side groups and a mixture thereof. In some examples, the thermoplastic resin may comprise a copolymer of an alkylene monomer, an ethylenically unsaturated monomer comprising an epoxide, and a monomer having acidic side groups. In some examples, the thermoplastic resin may comprise a copolymer of an alkylene monomer, an ethylenically unsaturated monomer comprising an epoxide, and a monomer having ester side groups. In some examples, the thermoplastic resin may comprise a copolymer of an alkylene monomer, an ethylenically unsaturated monomer comprising an epoxide, a monomer having acidic side groups and a monomer having ester side groups. In some examples, the alkylene monomer may be any alkylene monomer described herein. In some examples, the ethylenically unsaturated monomer comprising an epoxide may be any ethylenically unsaturated monomer comprising an epoxide described herein. In some examples, the monomer having acidic side groups may be any monomer having acidic side groups described herein.

In some examples, the monomer having ester side groups may be any monomer having ester side groups. In some examples, the monomer having ester side groups may be an ethylenically unsaturated ester, for example, an ester of an ethylenically unsaturated carboxylic acid and an alcohol or an ester of a carboxylic acid and an ethylenically unsaturated alcohol.

In some examples, the monomer having ester side groups may be an ester of an ethylenically unsaturated carboxylic acid and an alcohol. In some examples, the ethylenically unsaturated carboxylic acid may be an α,β-unsaturated carboxylic acid. In some examples, the α,β-unsaturated carboxylic acid may be an α,β-unsaturated, α-alkyl carboxylic acid. In some examples, the α,β-unsaturated carboxylic acid may be selected from propen-2-oic acid or an α,β-unsaturated, α-alkyl carboxylic acid described herein. In some examples, the α,β-unsaturated carboxylic acid may be propen-2-oic acid (also known as acrylic acid) or 2-methylprop-2-enoic acid (also known as methacrylic acid). In some examples, the alcohol may be a C1 to C10 alcohol, for example, methanol, ethanol, propanol, butanol, pentanol, or hexanol.

In some examples, the monomer having ester side groups may be an ester of a carboxylic acid and an ethylenically unsaturated alcohol. In some examples, the carboxylic acid may be methanoic acid, ethanoic acid, propanoic acid, butanoic acid, pentanoic acid or hexanoic acid. In some examples, the ethylenically unsaturated alcohol may be vinyl alcohol, hydroxypropene, hydroxybutene, hydroxypentene, or hydroxyhexene. In some examples, the ethylenically unsaturated alcohol may be vinyl alcohol.

In some example, the monomer having ester side groups may be methyl acrylate, methyl methacrylate, ethyl acrylate, ethyl methacrylate, propyl acrylate, propyl methacrylate, butyl acrylate, butyl methacrylate, pentyl acrylate, pentyl methacrylate, or vinyl acetate.

In some examples, the copolymer of an alkylene monomer, an ethylenically unsaturated monomer comprising an epoxide and a monomer having ester side groups may be a copolymer of ethylene, a monomer selected from glycidyl acrylate and glycidyl methacrylate, and a monomer selected from methyl acrylate, butyl acrylate and vinyl acetate. In some examples, the copolymer of an alkylene monomer, an ethylenically unsaturated monomer comprising an epoxide and a monomer having ester side groups may be a copolymer of ethylene, glycidyl methacrylate, and a monomer selected from methyl acrylate, butyl acrylate and vinyl acetate.

In some examples, the monomer comprising an epoxide may constitute about 1 wt. % to about 20 wt. % of the copolymer of an alkylene monomer, an ethylenically unsaturated monomer comprising an epoxide, and a monomer selected from a monomer having acidic side groups, a monomer having ester side groups and a mixture thereof, for example, about 2 wt. % to about 15 wt. %, about 3 wt. % to about 12 wt. %, about 4 wt. % to about 11 wt. %, about 5 wt. % to about 10 wt. %, about 6 wt. % to about 9 wt. %, about 7 wt. % to about 8 wt. % of the copolymer of an alkylene monomer, an ethylenically unsaturated monomer comprising an epoxide, and a monomer selected from a monomer having acidic side groups, a monomer having ester side groups and a mixture thereof. In some examples, the monomer comprising an epoxide may constitute at least about 1 wt. % of the copolymer of an alkylene monomer, an ethylenically unsaturated monomer comprising an epoxide, and a monomer selected from a monomer having acidic side groups, a monomer having ester side groups and a mixture thereof, for example, at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %. In some examples, the monomer comprising an epoxide may constitute up to about 20 wt. % of the copolymer of an alkylene monomer, an ethylenically unsaturated monomer comprising an epoxide, and a monomer selected from a monomer having acidic side groups, a monomer having ester side groups and a mixture thereof, for example, up to about 15 wt. %, up to about 14 wt. %, up to about 13 wt. %, up to about 12 wt. %, up to about 11 wt. %, up to about 10 wt. %, up to about 9 wt. %, up to about 8 wt. %, up to about 7 wt. %, up to about 6 wt. %, up to about 5 wt. %, up to about 4 wt. %, up to about 3 wt. %, up to about 2 wt. %, up to about 1 wt. % of the copolymer of an alkylene monomer, an ethylenically unsaturated monomer comprising an epoxide, and a monomer selected from a monomer having acidic side groups, a monomer having ester side groups and a mixture thereof. In some examples, the remaining weight percentage may constitute the alkylene monomer and the monomer selected from a monomer having acidic side groups, a monomer having ester side groups and a mixture thereof.

In some examples, the monomer selected from a monomer having acidic side groups monomer, a monomer having ester side groups and mixture thereof may constitute about 1 wt. % to about 35 wt. % of the copolymer of an alkylene monomer, an ethylenically unsaturated monomer comprising an epoxide, and a monomer selected from a monomer having acidic side groups, a monomer having ester side groups and a mixture thereof, for example, about 5 wt. % to about 30 wt. %, about 10 wt. % to about 28 wt. %, about 15 wt. % to about 27 wt. %, about 20 wt. % to 25 wt. %, about 23 wt. % to about 24 wt. % of the copolymer of an alkylene monomer, an ethylenically unsaturated monomer comprising an epoxide, and a monomer selected from a monomer having acidic side groups, a monomer having ester side groups and a mixture thereof. In some examples, the remaining weight percentage may constitute the alkylene monomer and the ethylenically unsaturated monomer comprising an epoxide.

In some examples, the copolymer of an alkylene monomer, an ethylenically unsaturated monomer comprising an epoxide, and a monomer selected from a monomer having acidic side groups, a monomer having ester side groups and a mixture thereof may comprise about 1 wt. % to about 20 wt. % of the ethylenically unsaturated monomer comprising an epoxide (for example, about 2 wt. % to about 15 wt. %, about 3 wt. % to about 12 wt. %, about 4 wt. % to about 11 wt. %, about 5 wt. % to about 10 wt. %, about 6 wt. % to about 9 wt. %, about 7 wt. % to about 8 wt. %); about 1 wt. % to about 35 wt. % of the monomer selected from a monomer having acidic side groups, a monomer having ester side groups and a mixture thereof (for example, about 5 wt. % to about 30 wt. %, about 10 wt. % to about 28 wt. %, about 15 wt. % to about 27 wt. %, about 20 wt. % to 25 wt. %, about 23 wt. % to about 24 wt. %); and the remaining weight percentage may be alkylene monomer.

In an example, the polymer or polymers of the resin can be selected from the Nucrel family of toners (e.g. Nucrel 403™, Nucrel 407™, Nucrel 609HS™, Nucrel 908HS™ Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), AC-5120 and AC 580 (sold by Honeywell), and the Lotader family of toners (e.g. Lotader 2210, Lotader, 3430, and Lotader 8200 (sold by Arkema)), poly(ethylene-co-glycidyl methacrylate) (sold by Merck), poly(ethylene-co-methyl acrylate-co-glycidyl methacrylate) (sold by Merck), Lotader AX8840, Lotader AX8820, Lotader™ AX8900, Lotader AX8930, Lotader™ AX8750, Lotader AX8670T, Igetabond™ CG5001, Igetabond™ BF-2C, Igetabond™ BR-E, Igetabond™ BF-2B, Igetabond™ BF-7B, Igetabond™ BR-7L and Igetabond™ BF-7M.

In some examples, the resin may constitute 5% to 99% by weight of the total solids in the liquid electrophotographic ink composition, in some examples 50% to 90% by weight of the total solids of the liquid electrophotographic ink composition, in some examples 65% to 80% by weight of the total solids of the liquid electrophotographic ink composition.

Carrier Liquid

In some examples, when printing, the liquid electrophotographic ink composition comprises a carrier liquid. Generally, the carrier liquid can act as a dispersing medium for the other components in the liquid electrophotographic ink composition. For example, the carrier liquid can comprise or be a hydrocarbon, silicone oil, vegetable oil, and so forth.

The carrier liquid can include, but is not limited to, an insulating, non-polar, non-aqueous liquid that can be used as a medium for toner particles. The carrier liquid can include compounds that have a resistivity in excess of about 10⁹ ohm·cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like.

In some examples, the carrier liquid may be a hydrocarbon. In some examples, the carrier liquid may be a branched chain hydrocarbon. In some examples, the branched chain hydrocarbon may comprise 5 to 15 carbon atoms, for example, 10 to 15 carbon atoms, or 11 to 12 carbon atoms. In some examples, the carrier liquid may be selected from liquids comprising a mixture of branched chain hydrocarbons having 5 to 15 carbon atoms, for example, 10 to 15 carbon atoms or 11 to 12 carbon atoms.

In particular, the liquid carriers can include, but are not limited to, Isopar-G™, Isopar-H™, Isopar-L™, Isopar-M™, Isopar-K™, Isopar-V™, Norpar 12™, Norpar 13™, Norpar 1γ™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before liquid electrophotographic printing, the carrier liquid can constitute about 20% to 99.5% by weight of the liquid electrostatic ink composition, in some examples 50% to 99.5% by weight of the liquid electrostatic ink composition. Before printing, the carrier liquid may constitute about 40% to 90% by weight of the liquid electrostatic ink composition. Before printing, the carrier liquid may constitute about 60% to 80% by weight of the liquid electrostatic ink composition. Before printing, the liquid carrier may constitute about 90% to 99.5% by weight of the liquid electrostatic ink composition, in some examples 95% to 99% by weight of the liquid electrostatic ink composition.

The liquid electrostatic ink composition, once electrostatically printed on the substrate, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that liquid electrostatically printed ink contains less than 5 wt. % liquid carrier, in some examples, less than 2 wt. % liquid carrier, in some examples less than 1 wt. % liquid carrier, in some examples less than 0.5 wt. % liquid carrier. In some examples, liquid electrostatically printed ink is free from liquid carrier.

Charge Director

In some examples, the LEP ink composition further includes a charge director. The charge director may be added in order to impart and/or maintain sufficient electrostatic charge on the ink particles, which may be particles comprising the thermoplastic resin. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of a LEP ink composition.

In some examples, the liquid electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO₃⁻, NO₃⁻, HOP₄²⁻, CO₃²⁻, acetate, trifluoroacetate (TFA), Cl⁻, BF₄⁻, F⁻, ClO₄⁻, and TiO₃⁴⁻ or from any sub-group thereof. The simple salt may be selected from CaCO₃, Ba₂TiO₃, Al₂ (SO₄), Al(NO₃)₃, Ca₃ (PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂ (SO₄)₃, LiCIO₄ and LiBF₄, or any sub-group thereof.

In some examples, the electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃—)—C(O)—O—R²], wherein each of R¹ and R² is an alkyl group. In some examples each of R 1 and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ, is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20% by weight, in some examples 0.01% to 20% by weight, in some examples 0.01% to 10% by weight, in some examples 0.01% to 5% by weight of the total solids of a liquid electrostatic ink composition. In some examples, the charge director constitutes about 1% to 4% by weight of the total solids of the liquid electrostatic ink composition, in some examples 2% to 4% by weight of the total solids of the electrostatic ink composition.

In some examples, the charge director is present in an amount sufficient to achieve a particle conductivity of 500 pmho/cm or less, in some examples, 450 pmho/cm or less, in some examples, 400 pmho/cm or less, in some examples, 350 pmho/cm or less, in some examples, 300 pmho/cm or less, in some examples, 250 pmho/cm or less, in some examples, 200 pmho/cm or less, in some examples, 190 pmho/cm or less, in some examples, 180 pmho/cm or less, in some examples, 170 pmho/cm or less, in some examples, 160 pmho/cm or less, in some examples, 150 pmho/cm or less, in some examples, 140 pmho/cm or less, in some examples, 130 pmho/cm or less, in some examples, 120 pmho/cm or less, in some examples, 110 pmho/cm or less, in some examples, about 100 pmho/cm. In some examples, the charge director is present in an amount sufficient to achieve a particle conductivity of 50 pmho/cm or more, in some examples, 60 pmho/cm or more, in some examples, 70 pmho/cm or more, in some examples, 80 pmho/cm or more, in some examples, 90 pmho/cm or more, in some examples, about 100 pmho/cm, in some examples, 150 pmho/cm or more, in some examples, 200 pmho/cm or more, in some examples, 250 pmho/cm or more, in some examples, 300 pmho/cm or more, in some examples, 350 pmho/cm or more, in some examples, 400 pmho/cm or more, in some examples, 450 pmho/cm or more, in some examples, 500 pmho/cm or more. In some examples, the charge director is present in an amount sufficient to achieve a particle conductivity of 50 pmho/cm to 500 pmho/cm, in some examples, 60 pmho/cm to 450 pmho/cm, in some examples, 70 pmho/cm to 400 pmho/cm, in some examples, 80 pmho/cm to 350 pmho/cm, in some examples, 90 pmho/cm to 300 pmho/cm, in some examples, 100 pmho/cm to 250 pmho/cm, in some examples, 110 pmho/cm to 200 pmho/cm, in some examples, 120 pmho/cm to 500 pmho/cm, in some examples, 130 pmho/cm to 450 pmho/cm, in some examples, 140 pmho/cm to 400 pmho/cm, in some examples, 150 pmho/cm to 350 pmho/cm, in some examples, 160 pmho/cm to 300 pmho/cm.

In some examples, the charge director is present in an amount of from 3 mg/g to 50 mg/g, in some examples from 3 mg/g to 45 mg/g, in some examples from 10 mg/g to 40 mg/g, in some examples from 5 mg/g to 35 mg/g, in some examples, 20 mg/g to 35 mg/g, in some examples, 22 mg/g to 34 mg/g (where mg/g indicates mg per gram of solids of the liquid electrostatic ink composition).

Charge Adjuvant

In some examples, the LEP ink composition further includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), or hydroxy bis(3,5-di-tert-butyl salicylic)aluminate monohydrate. In an example, the charge adjuvant is or includes aluminum di- or tristearate. In some examples, the charge adjuvant is VCA (aluminium stearate and aluminium palmitate, available from Sigma Aldrich).

The charge adjuvant may be present in an amount of about 0.1% to 5% by weight, in some examples about 0.1% to 1% by weight, in some examples about 0.3% to 0.8% by weight of the total solids of the liquid electrostatic ink composition, in some examples, about 1 wt. % to 5 wt. % of the total solids of the liquid electrostatic ink, in some examples about 1 wt. % to 3 wt. % of the total solids of the liquid electrostatic ink composition, in some examples about 1.5 wt. % to 2.5 wt. % of the total solids of the liquid electrostatic ink composition.

The charge adjuvant may be present in an amount of less than 5% by weight of total solids of the liquid electrostatic ink composition, in some examples in an amount of less than 4.5% by weight, in some examples in an amount of less than 4% by weight, in some examples in an amount of less than 3.5% by weight, in some examples in an amount of less than 3% by weight, in some examples in an amount of less than 2.5% by weight, in some examples, in an amount of less than 2% by weight of the total solids of the liquid electrostatic ink composition.

In some examples, the liquid electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al 3+. The fatty acid anion may be selected from a saturated or unsaturated fatty acid anion. The fatty acid anion may be selected from a C8 to C26 fatty acid anion, in some examples a C14 to C22 fatty acid anion, in some examples a C16 to C20 fatty acid anion, in some examples a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the total solids of the liquid electrostatic ink composition, in some examples in an amount of 0.1 wt. % to 3 wt. % of the total solids of the liquid electrostatic ink composition, in some examples about 1 wt. % to 3 wt. % of the total solids of the liquid electrostatic ink composition, in some examples about 1.5 wt. % to 2.5 wt. % of the total solids of the liquid electrostatic ink composition.

Additives

The liquid electrophotographic (LEP) ink composition may include another additive or a plurality of other additives. The other additive or plurality of other additives may be added at any stage of the method. The other additive or plurality of other additives may be selected from a charge adjuvant, a wax, a surfactant, viscosity modifiers, and compatibility additives. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket. In some examples, the LEP ink composition comprises silica, which may be added, for example, to improve the durability of images produced using the LEP ink. The other additives may constitute 10 wt. % or less of the total solids of the electrostatic ink composition, in some examples, 5 wt. % or less of the total solids of the electrostatic ink composition, in some examples, 3 wt. % or less of the total solids of the electrostatic ink composition.

Method of Producing a Material with a Perovskite Structure on a Substrate

In an aspect, there is provided a method of producing a material with a perovskite structure on a substrate. In some examples, the material with a perovskite structure has a chemical formula selected form ABX₃ and A₂BX₆. In some examples, the material with a perovskite structure has the chemical formula ABX₃. In some examples, the material with a perovskite structure has the chemical formula A₂BX₆. In some examples, there is provided a method of producing a material with a perovskite structure on a substrate by liquid electrophotographic (LEP) printing.

In some examples, the method of producing a material with a perovskite structure on a substrate by liquid electrophotographic (LEP) printing may comprise either liquid electrophotographically printing onto the substrate a composition comprising a dispersion of a salt AX and a thermoplastic resin in a carrier liquid; liquid electrophotographically printing onto the substrate a composition comprising a dispersion of a salt selected from BX₂ and BX₄ and a thermoplastic resin in a carrier liquid; and heat treating the printed compositions to form the material with a perovskite structure; or liquid electrophotographically printing onto the substrate a composition comprising a dispersion of a material with a perovskite structure and a thermoplastic resin in a carrier liquid to form the material with a perovskite structure.

In some examples, A is a cation, B is a cation and X is an anion. In some examples, the material with a perovskite structure has the chemical formula ABX₃, wherein A is a monovalent cation, B is a divalent cation and X is a monovalent anion. In some examples, the material with a perovskite structure has the chemical formula ABX₃, wherein A is a divalent cation, B is a tetravalent cation and X is a monovalent cation. In some examples, the material with a perovskite structure has the chemical formula A₂BX₆, wherein A is a monovalent cation, B is a tetravalent cation and X is a monovalent anion.

In some examples, the thermoplastic resin comprises a copolymer of an alkylene monomer and a monomer having acidic side groups; and/or a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof.

In some examples, the thermoplastic resin comprises a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof and the method of producing a material with a perovskite structure on a substrate further comprises curing the thermoplastic resin. In some examples, curing the thermoplastic resin may comprise heating the thermoplastic resin to a temperature of at least about 100° C., for example, at least about 105° C., at least about 110° C., at least about 115° C., at least about 120° C. In some examples, curing the thermoplastic resin may comprise heating the thermoplastic resin to a temperature of about 100° C. to about 150° C., for example, about 105° C. to about 145° C., about 110° C. to about 140° C., about 115° C. to about 135° C., about 120° C. to about 130° C., about 120° C. to about 130° C. In some examples, heating may be performed for at least about 1 min, for example, at least about 2 min, at least about 3 min, at least about 4 min, at least about 5 min. In some examples, heating may be performed for about 1 min to about 30 min, for example, about 2 min to about 25 min, about 3 min to about 20 min, about 4 min to about 15 min, about 5 min to about 10 min. In some examples, curing the thermoplastic resin comprises a ring-opening reaction of the epoxide. In some examples, curing the thermoplastic resin comprises a cross-linking reaction of the epoxide. In some examples, curing the thermoplastic resin comprises reacting the epoxide of the thermoplastic resin with the surface of the substrate. In some examples, the epoxide of the thermoplastic resin reacts with functional groups on the surface of the substrate, such as peroxides, hydroxyls, aldehydes, ketones or carboxylic acid groups.

In some examples, the substrate is subjected to corona treatment prior to printing the electrostatic ink composition. In some examples, corona treatment may improve the surface polarity of the substrate. During the corona treatment, polar groups, such as peroxides, hydroxyls, aldehydes, ketones or carboxylic acid groups, may be grafted onto the surface of the substrate. The corona treatment may be performed in a corona chamber at room temperature and atmospheric pressure.

In some examples, the method of producing a material with a perovskite structure on a substrate by liquid electrophotographic (LEP) printing may comprise liquid electrophotographically printing onto the substrate a composition comprising a dispersion of a salt AX and a thermoplastic resin in a carrier liquid; liquid electrophotographically printing onto the substrate a composition comprising a dispersion of a salt selected from BX₂ and BX₄ and a thermoplastic resin in a carrier liquid; and heat treating the printed compositions to form the material with a perovskite structure. In some examples, the method of producing a material with a perovskite structure on a substrate by liquid electrophotographic (LEP) printing may comprise liquid electrophotographically printing onto the substrate a composition comprising a dispersion of a salt AX and a thermoplastic resin in a carrier liquid; liquid electrophotographically printing onto the substrate a composition comprising a dispersion of a salt BX₂ and a thermoplastic resin in a carrier liquid; and heat treating the printed compositions to form the material with a perovskite structure. In some examples, the method of producing a material with a perovskite structure on a substrate by liquid electrophotographic (LEP) printing may comprise liquid electrophotographically printing onto the substrate a composition comprising a dispersion of a salt AX and a thermoplastic resin in a carrier liquid; liquid electrophotographically printing onto the substrate a composition comprising a dispersion of a salt BX₄ and a thermoplastic resin in a carrier liquid; and heat treating the printed compositions to form the material with a perovskite structure. In some examples, the thermoplastic resin comprises a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof and the heat treatment of the printed composition additionally cures the thermoplastic resin. In some examples, the substrate is subjected to corona treatment prior to the liquid electrophotographic printing of the composition onto the substrate.

In some examples, the heat treatment may comprise heating the printed compositions at 50° C. or more, for example, 60° C. or more, 70° C. or more, 80° C. or more, 90° C. or more, 100° C. or more, 110° C. or more, 120° C. or more, 130° C. or more, 140° C. or more, 150° C. or more, 160° C. or more, 170° C. or more, 180° C. or more, 190° C. or more, 200° C. or more. In some examples, the heat treatment may comprise heating the printed compositions at 200° C. or less, for example, 190° C. or less, 180° C. or less, 170° C. or less, 160° C. or less, 150° C. or less, 140° C. or less, 130° C. or less, 120° C. or less, 110° C. or less, 100° C. or less, 90° C. or less, 80° C. or less, 70° C. or less, 60° C. or less, or 50° C. or less. In some examples, the heat treatment may comprise heating the printed compositions at 50° C. to 200° C., for example, 60° C. to 190° C., 70° C. to 180° C., 80° C. to 170° C., 90° C. to 160° C., 90° C. to 150° C., 100° C. to 140° C., 50° C. to 130° C., 70° C. to 120° C., 80° C. to 110° C. or 90° C. to 100° C. In some examples, the heat treatment may comprise heating for 30 s or more, for example, 40 s or more, 50 s or more, 1 min or more, 1 min 10 s or more, 1 min 20 s or more, 1 min 30 s or more, 1 min 40 s or more, 1 min 50 s or more, 2 min or more, 2 min 10 s or more, 2 min 20 s or more, 2 min 30 s or more, 2 min 40 s or more, 2 min 50 s or more, or 3 min or more. In some examples, the heat treatment may comprise heating for 3 min or less, for example, 2 min 50 s or less, 2 min 40 s or less, 2 min 30 s or less, 2 min 20 s or less, 2 min 10 s or less, 2 min or less, 1 min 50 s or less, 1 min 40 s or less, 1 min 30 s or less, 1 min 20 s or less, 1 min 10 s or less, 1 min or less, 50 s or less, 40 s or less, or 30 s or less. In some examples, the heat treatment may comprise heating for 30 s to 3 min, for example, 40 s to 2 min 50 s, 50 s to 2 min 40 s, 1 min to 2 min 30 s, 1 min 10 s to 2 min 20 s, 1 min 20 s to 2 min 10 s, 1 min 30 s to 2 min, 1 min 40 s to 3 min, 1 min 50 s to 2 min 30 s, 1 min 50 s to 2 min 20 s, or 2 min to 2 min 10 s.

In some examples, the method of producing a material with a perovskite structure on a substrate by liquid electrophotographic (LEP) printing may comprise liquid electrophotographically printing onto the substrate a composition comprising a dispersion of a material with a perovskite structure and a thermoplastic resin in a carrier liquid to form the material with a perovskite structure. In some examples, the thermoplastic resin comprises a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof and the method further comprises curing the thermoplastic resin. In some examples, curing the thermoplastic resin comprises a ring-opening reaction of the epoxide. In some examples, curing the thermoplastic resin comprises a cross-linking reaction of the epoxide.

In some examples, the method of producing a material with a perovskite structure on a substrate by liquid electrophotographic (LEP) printing may comprise liquid electrophotographically printing onto the substrate a composition comprising a dispersion of a material with a perovskite structure and a thermoplastic resin in a carrier liquid to form the material with a perovskite structure, wherein the composition comprising a dispersion of a material with a perovskite structure and a thermoplastic resin in a carrier liquid was formed by combining a liquid electrophotographic ink composition comprising a dispersion of a salt AX and a thermoplastic resin in a carrier liquid with a liquid electrophotographic ink composition comprising a dispersion of a salt selected from BX₂ and BX₄ and a thermoplastic resin in a carrier liquid; or by dispersing a salt AX, a salt selected from BX₂ and BX₄, and a thermoplastic resin in a carrier liquid.

In some examples, the method of producing a material with a perovskite structure on a substrate by liquid electrophotographic (LEP) printing may comprise liquid electrophotographically printing onto the substrate a composition comprising a dispersion of a material with a perovskite structure and a thermoplastic resin in a carrier liquid to form the material with a perovskite structure, wherein the composition comprising a dispersion of the material with a perovskite structure and a thermoplastic resin in a carrier liquid was formed by combining a liquid electrophotographic ink composition comprising a dispersion of a salt AX and a thermoplastic resin in a carrier liquid with a liquid electrophotographic ink composition comprising a dispersion of a salt selected from BX₂ and BX₄ and a thermoplastic resin in a carrier liquid.

In some examples, the method of producing a material with a perovskite structure on a substrate by liquid electrophotographic (LEP) printing may comprise liquid electrophotographically printing onto the substrate a composition comprising a dispersion of a material with a perovskite structure and a thermoplastic resin in a carrier liquid to form the material with a perovskite structure, wherein the composition comprising a dispersion of a material with a perovskite structure and a thermoplastic resin in a carrier liquid was formed by dispersing a salt AX, a salt selected from BX₂ and BX₄, and a thermoplastic resin in a carrier liquid.

In some examples, the material with a perovskite structure on the substrate may have a thickness of 0.1 μm or more, for example, 0.2 μm or more, 0.3 μm or more, 0.4 μm or more, 0.5 μm or more, 0.6 μm or more, 0.7 μm or more, 0.8 μm or more, 0.9 μm or more, 1 μm or more. In some examples, the material with a perovskite structure on the substrate may have a thickness of 1 μm or less, for example, 0.9 μm or less, 0.8 μm or less, 0.7 μm or less, 0.6 μm or less, 0.5 μm or less, 0.4 μm or less, 0.3 μm or less, 0.2 μm or less, 0.1 μm or less. In some examples, the material with a perovskite structure on the substrate may have a thickness of 0.1 μm to 1 μm for example, 0.2 μm to 0.9 μm, 0.3 μm to 0.8 μm, 0.4 μm to 0.7 μm, or 0.5 μm to 0.6 μm.

In some examples, the material with a perovskite structure on the substrate may form the light harvesting active layer of a photovoltaic cell.

In some examples, liquid electrophotographically printing a composition onto the substrate comprises contacting the composition with a latent electrostatic image on a surface to create a developed image and transferring the developed image to the substrate, in some examples, via an intermediate transfer member.

In some examples, the surface on which the (latent) electrostatic image is formed or developed may be a rotating member, for example, in the form of a cylinder. The surface on which the (latent) electrostatic image is formed or developed may form a part of a photo imaging plate (PIP). The method may involve passing the ink composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, for example, to a temperature of from 80 to 160° C.

In some examples, liquid electrophotographically printing a composition onto the substrate comprises contacting the composition with a latent electrostatic image on a surface to create a developed image and transferring the developed image to the substrate, in some examples, via an intermediate transfer member and then curing the developed image on the substrate. In some examples, curing the developed image may comprise heating the developed image.

Method of Producing the Liquid Electrophotographic Ink Composition Comprising AX

In some examples, the method of producing a liquid electrophotographic ink composition comprising a dispersion of a salt AX and a thermoplastic resin in a carrier liquid comprises combining the salt AX, the thermoplastic resin and the carrier liquid. In some examples, the method of producing the liquid electrophotographic ink composition comprising a dispersion of a salt AX and a thermoplastic resin in a carrier liquid comprises dispersing a salt AX and a thermoplastic resin in a carrier liquid.

In some examples, the method of producing a liquid electrophotographic ink composition comprising a dispersion of a salt AX and a thermoplastic resin in a carrier liquid may comprise combining the thermoplastic resin with the carrier liquid before adding the salt AX to the combined thermoplastic resin and carrier liquid. In some examples, the method of producing a liquid electrophotographic ink composition comprising a dispersion of a salt AX and a thermoplastic resin in a carrier liquid may comprise dispersing the thermoplastic resin in the carrier liquid before adding the salt AX to the dispersion of the thermoplastic resin in the carrier liquid.

In some examples, combining the salt AX with the thermoplastic resin and the carrier liquid may comprise grinding the salt AX and the thermoplastic resin in the presence of the carrier liquid.

In some examples, the method of producing a liquid electrophotographic ink composition comprising a dispersion of a salt AX and a thermoplastic resin in a carrier liquid may comprise adding a charge adjuvant to the liquid electrophotographic ink composition. In some examples, the charge adjuvant may be added to the liquid electrophotographic ink composition before, during or after the salt AX, the thermoplastic resin and the carrier liquid are combined. In some examples, the charge adjuvant may be added to the liquid electrophotographic ink composition before, during or after addition of the salt AX to the combined thermoplastic resin and carrier liquid.

In some examples, the method of producing a liquid electrophotographic (LEP) ink composition comprising a dispersion of a salt AX and a thermoplastic resin in a carrier liquid may comprise adding a charge director to the liquid electrophotographic ink composition. In some examples, the charge director may be added to the liquid electrophotographic ink composition before, during or after the salt AX, the thermoplastic resin and the carrier liquid are combined. In some examples, the charge director may be added to the liquid electrophotographic ink composition before, during or after addition of the salt AX to the combined thermoplastic resin and carrier liquid. In some examples, the charge director may be added to the liquid electrophotographic ink composition before, during or after the charge adjuvant is added to the liquid electrophotographic ink composition.

In some examples, the method of producing an LEP ink composition may comprise suspending a thermoplastic resin in a carrier liquid before adding the salt AX. In some examples, the method may comprise suspending a first thermoplastic resin and a second thermoplastic resin in a carrier liquid. In some examples, the LEP ink composition comprises chargeable particles comprising a first thermoplastic resin and a second thermoplastic resin. In some examples, the method of producing an LEP ink composition may comprise suspending chargeable particles comprising a first thermoplastic resin and a second thermoplastic resin in a carrier liquid.

In some examples, the method of producing an LEP ink composition may comprise dispersing a first thermoplastic resin and a second thermoplastic resin in a carrier liquid. In some examples, the method of producing an LEP ink composition may comprise dispersing chargeable particles comprising a first thermoplastic resin and a second thermoplastic resin in a carrier liquid.

In some examples, the method of producing an LEP ink composition may comprise combining a thermoplastic resin (for example, the first thermoplastic resin) with the carrier liquid and subsequently adding the other resin (for example, the second resin). In some examples, the method of producing an LEP ink composition comprises combining a resin (for example, the first resin) with the carrier liquid to form a paste and subsequently adding the other resin (for example, the second resin). In some examples, the resin and the carrier liquid are combined and heated to an elevated temperature before adding the other resin, which may have also been heated to an elevated temperature. In some examples, the resin and the carrier liquid are combined and heated to a temperature above the melting point of the resin before adding the other resin, which may have also been heated to a temperature above its melting point. In some examples, the resin and carrier liquid are combined and heated until the resin has melted and/or dissolved in the carrier liquid before adding the other resin. In some examples, adding the other resin to the combined resin and carrier liquid comprises mixing the other resin with the combined resin and carrier liquid.

The melting point of the resin may be determined by differential scanning calorimetry, for example, using ASTM D3418.

In some examples, the resin and the carrier liquid are combined and heated to a temperature of at least 70° C., for example, at least 80° C., for example, at least 90° C., for example, at least 100° C., for example, at least 110° C., for example, at least 120° C., for example, 130° C., for example, to melt the resin. In some examples, the other resin is heated before being added to the combined resin and carrier liquid. In some examples, the other resin is heated to at least 30° C., in some examples, at least 40° C., in some examples, at least 45° C., in some examples, at least 50° C. before being added to the combined resin and carrier liquid. In some examples, the other resin is heated to 100° C. or less, in some examples, 90° C. or less, in some examples, 80° C. or less, in some examples, 75° C. or less, in some examples, 70° C. or less, in some examples, 60° C. or less before being added to the combined resin and carrier liquid. In some examples, the other resin is heated to reduce the viscosity of the other resin before being added to the first resin and the carrier liquid.

In some examples, the method comprises combining the first resin with the carrier liquid to form a first composition; combining the second resin with the carrier liquid to form a second composition; and subsequently combining the first composition and the second composition to form a liquid electrophotographic ink composition. In some examples, the method comprises combining the first resin with the carrier liquid to form a first paste; combining the second resin with the carrier liquid to form a second paste; and subsequently combining the first paste and the second paste to form a liquid electrophotographic ink composition. In some examples, the first resin and the carrier liquid are combined and heated to an elevated temperature to form a first heated composition; the second resin and the carrier liquid are combined and heated to an elevated temperature to form a second heated composition; and subsequently the first heated composition and the second heated composition are combined. In some examples, the first resin and the carrier liquid are combined and heated to a temperature above the melting point of the first resin to form a first heated composition; the second resin and the carrier liquid are combined and heated to a temperature above the melting point of the second resin to form a second heated composition; and subsequently the first heated composition and the second heated composition are combined. In some examples, the first composition and the second composition are heated to the same temperature, which may be a temperature above the melting temperature of all of the resins.

In some examples, the method of producing an LEP ink composition comprises mixing the first resin and the second resin together and then combining the mixture of the resins with the carrier liquid.

In some examples, the first resin and the second resin are combined with the carrier liquid and subsequently heated to an elevated temperature. In some examples, the first resin and the second resin are combined with the carrier liquid and subsequently heated to a temperature above the melting point of at least one, optionally all, of the resins. In some examples, the first resin and the second resin are combined with the carrier liquid and subsequently heated to a temperature of at least 70° C., for example, at least 80° C., for example, at least 90° C., for example, at least 100° C., for example, at least 110° C., for example, at least 120° C., for example, 130° C., for example, to melt at least one, optionally all, of the resins. In some examples, the combined first resin, second resin and carrier liquid are heated until all of the resins have melted and/or dissolved in the carrier liquid.

In some examples, the method of producing a liquid electrophotographic ink composition comprises combining a first resin, a second resin, and a carrier liquid.

In some examples, the chargeable particles comprise the first resin and the second resin.

Melting and/or dissolving a resin (or resins) in the carrier liquid may result in the carrier fluid appearing clear and homogeneous. In some examples, the resin (or resins) and carrier liquid are heated before, during or after mixing.

In some examples, the resin (or resins) and the carrier liquid are mixed at a mixing rate of 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the resin (or resins) in the carrier liquid is complete.

In some examples, after combining and heating the resins and the carrier liquid, the mixture is cooled to a temperature below the melting point of the resins, for example, to room temperature. In some examples, the chargeable particles are removed from the carrier liquid and re-dispersed in a new portion of carrier liquid, which may be the same or a different carrier liquid.

In some examples, the method of producing an LEP ink composition comprises adding a salt AX to the combined first resin, second resin and carrier liquid. In some examples, the method of producing an LEP ink composition comprises adding a salt AX to the combined first resin, second resin and carrier liquid to form chargeable particles comprising the resins and a salt AX. In some examples, the method of producing an LEP ink composition comprises grinding the salt AX and the resins in the presence of the carrier liquid to form a paste. In some examples, the method of producing an LEP ink composition comprises heating and mixing the salt AX and the resins in the presence of the carrier liquid to form a paste.

In some examples, the method of producing an LEP ink composition comprises adding a charge adjuvant to the combined first resin, second resin and carrier liquid and optionally grinding. In some examples, the method of producing an LEP ink composition comprises adding a charge adjuvant and a salt AX to the combined first resin, second resin and carrier liquid and optionally grinding. In some examples, the method of producing an LEP ink composition comprises adding a charge adjuvant to the combined first resin, second resin, salt AX and carrier liquid and optionally grinding.

In some examples, the method of producing an LEP ink composition comprises grinding at a grinding speed of at least 50 rpm. In some examples, the method of producing an LEP ink composition comprises grinding at a grinding speed of up to about 600 rpm. In some examples, the method of producing an LEP ink composition comprises grinding for at least 1 h, in some examples, for at least 2 h. In some examples, the method of producing an LEP ink composition comprises grinding for up to about 12 h. In some examples, the method of producing an LEP ink composition comprises grinding at a temperature of at least about 30° C., for example, at least about 35° C., for example, at least about 40° C., for example, at least about 50° C. In some examples, the method of producing an LEP ink composition comprises grinding at a temperature of at least about 50° C. for a first time period, in some examples, for at least 1 h, in some examples, for at least 1.5 h and then reducing the temperature to a temperature of at least 30° C., in some examples, at least 35° C. and continuing grinding for at least 5 h, in some examples, at least 9 h, in some examples, at least 10 h.

In some examples, the method of producing an LEP ink composition comprises adding a charge director to the combined first resin, second resin and carrier liquid. In some examples, the method of producing an LEP ink composition comprises adding a charge director to the combined first resin, second resin, salt AX and carrier liquid. In some examples, the method of producing an LEP ink composition comprises adding a charge director to the combined first resin, second resin, charge adjuvant and carrier liquid. In some examples, the method of producing an LEP ink composition comprises adding a charge director to the combined first resin, second resin, salt AX, charge adjuvant and carrier liquid.

Method of Producing the Liquid Electrophotographic Ink Composition Comprising BX₂

In some examples, the liquid electrophotographic ink composition comprising a dispersion of a salt BX₂ and a thermoplastic resin in a carrier liquid may be produced by the method described above for producing the liquid electrophotographic ink composition comprising the salt AX except that the salt BX₂ is used instead of the salt AX.

Method of Producing the Liquid Electrophotographic Ink Composition Comprising BX₄

In some examples, the liquid electrophotographic ink composition comprising a dispersion of a salt BX₄ and a thermoplastic resin in a carrier liquid may be produced by the method described above for producing the liquid electrophotographic ink composition comprising the salt AX except that the salt BX₄ is used instead of the salt AX.

Method of Producing the Liquid Electrophotographic Ink Composition Comprising a Material with a Perovskite Structure

In some examples, the liquid electrophotographic ink composition comprising a dispersion of a material with a perovskite structure and a thermoplastic resin in a carrier liquid may be produced by the method described above for producing the liquid electrophotographic ink composition comprising the salt AX except that a combination of the salt AX and a salt selected from BX₂ and BX₄ is used instead of the salt AX. In some examples, the liquid electrophotographic ink composition comprising a dispersion of a material with a perovskite structure and a thermoplastic resin in a carrier liquid (wherein the material with a perovskite structure has the chemical formula ABX₃) may be produced by the method described above for producing the liquid electrophotographic ink composition comprising the salt AX except that the salts AX and BX₂ are used in a 1:1 ratio (by number of moles of each salt) instead of the salt AX. In some examples, the liquid electrophotographic ink composition comprising a dispersion of material with a perovskite structure and a thermoplastic resin in a carrier liquid (wherein the material with a perovskite structure has the chemical formula A₂BX₆) may be produced by the method described above for producing the liquid electrophotographic ink composition comprising the salt AX except that the salts AX and BX₄ are used in a 2:1 ratio (by number of moles of each salt) instead of the salt AX.

In some examples, the liquid electrophotographic ink composition comprising a dispersion of a material with a perovskite structure and a thermoplastic resin in a carrier liquid may be produced by combining a composition comprising a dispersion of a salt AX and a thermoplastic resin in a carrier liquid with a composition comprising a dispersion of a salt selected from BX₂ and BX₄ and a thermoplastic resin in a carrier liquid. In some examples, the liquid electrophotographic ink composition comprising a dispersion of a material with a perovskite structure and a thermoplastic resin in a carrier liquid (wherein the material with a perovskite structure has the chemical formula ABX₃) may be produced by combining, in a 1:1 ratio (by number of moles of each salt), a composition (for example, a liquid electrophotographic ink composition) comprising a dispersion of a salt AX and a thermoplastic resin in a carrier liquid with a composition (for example, a liquid electrophotographic ink composition) comprising a dispersion of a salt BX₂ and a thermoplastic resin in a carrier liquid. In some examples, the liquid electrophotographic ink composition comprising a dispersion of a material with a perovskite structure and a thermoplastic resin in a carrier liquid (wherein the material with a perovskite structure has the chemical formula A₂BX₆) may be produced by combining, in a 2:1 ratio (by number of moles of each salt), a composition (for example, a liquid electrophotographic ink composition) comprising a dispersion of a salt AX and a thermoplastic resin in a carrier liquid with a composition (for example, a liquid electrophotographic ink composition) comprising a dispersion of a salt BX₄ and a thermoplastic resin in a carrier liquid.

In some examples, the liquid electrophotographic ink composition comprising a dispersion of material with a perovskite structure and a thermoplastic resin in a carrier liquid may be produced by combining, in a stoichiometric ratio, a composition (for example, a liquid electrophotographic ink composition) comprising a dispersion of a salt AX and a thermoplastic resin in a carrier liquid with a composition (for example, a liquid electrophotographic ink composition) comprising a dispersion of a salt selected from BX₂ and BX₄ and a thermoplastic resin in a carrier liquid.

In some examples, the composition comprising a dispersion of a salt AX and a thermoplastic resin in a carrier liquid was mixed by high shear mixing prior to being combined with the dispersion of a salt selected from BX₂ and BX₄ and a thermoplastic resin in a carrier liquid. In some examples, the composition comprising a dispersion of a salt selected from BX₂ and BX₄ and a thermoplastic resin in a carrier liquid was mixed by high shear mixing prior to being combined with the dispersion of a salt AX and a thermoplastic resin in a carrier liquid. In some examples, the composition comprising a dispersion of a salt AX and a thermoplastic resin in a carrier liquid and the composition comprising a dispersion of a salt selected from BX₂ and BX₄ and a thermoplastic resin in a carrier liquid were separately mixed by high shear mixing prior to the two compositions being combined. In some examples, high shear mixing comprises mixing at a shear rate of up to 35000 rpm, for example, up to 30000 rpm, or up to 25000 rpm. In some examples, high shear mixing comprises mixing at a shear rate of at least 7000 rpm, for example, at least 10000 rpm, at least 15000 rpm, at least 20000 rpm or at least 25000 rpm. In some examples, high shear mixing comprises mixing at a shear rate of 7000 rpm to 35000 rpm, for example, 10000 rpm to 30000 rpm, or 15000 rpm to 25000 rpm.

In some examples, combining a composition comprising a dispersion of a salt AX and a thermoplastic resin in a carrier liquid with a composition comprising a dispersion of a salt BX₂ or a salt BX₄ and a thermoplastic resin in a carrier liquid may comprise mixing the two compositions for 10 min or less, for example, 5 min or less, 4 min or less, 3 min or less, 2 min or less, 1 min or less. In some examples, combining a composition comprising a dispersion of a salt AX and a thermoplastic resin in a carrier liquid with a composition comprising a dispersion of a salt BX₂ or a salt BX₄ and a thermoplastic resin in a carrier liquid may comprise mixing the two compositions for 1 min or more, for example, 2 min or more, 3 min or more, 4 min or more, 5 min or more, 10 min or more. In some example, combining a composition comprising a dispersion of a salt AX and a thermoplastic resin in a carrier liquid with a composition comprising a dispersion of a salt BX₂ and a thermoplastic resin in a carrier liquid may comprise mixing the two compositions for 1 min to 10 min, for example, 2 min to 5 min, 3 min to 4 min. In some examples, the mixing may be at room temperature, for example, about 25° C. In some examples, the mixing speed may be 50 rpm or less. In some examples, the mixing may be performed manually over a few minutes. In some examples, the mixture may then be rested for a period of time to form the material with a perovskite structure. In some examples, the period of time may be 1 h or more, for example, 1.5 h or more, 2 h or more, 2.5 h or more, 3 h or more. In some examples, the period of time may be 3 h or less, for example, 2.5 h or less, 2 h or less, 1.5 h or less, or 1 h or less. In some examples, the period of time may be 1 h to 3 h, for example, 1.5 h to 2.5 h or 2 h to 2.5 h.

Printed Substrate

In another aspect, there is provided a printed substrate. The printed substrate may comprise a substrate; and a liquid electrophotographically printed composition comprising a thermoplastic resin and a material with a perovskite structure disposed on the substrate. In some examples, the printed substrate may comprise a substrate; and a liquid electrophotographically printed composition comprising a cured thermoplastic resin and a material with a perovskite structure disposed on the substrate. In some examples, the printed substrate may comprise a substrate; and a liquid electrophotographically printed composition comprising a thermoplastic resin and a material with a perovskite structure disposed on the substrate; wherein the material with a perovskite structure has a chemical formula selected from ABX₃ and A₂BX₆, wherein A is a cation, B is a cation and X is an anion; and wherein the thermoplastic resin comprises a copolymer of an alkylene monomer and a monomer having acidic side groups; and/or a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof. In some examples, the epoxide may have been cured. In some examples, the curing may have ring-opened the epoxide. In some examples, the printed substrate may comprise a substrate; and a liquid electrophotographically printed composition comprising a thermoplastic resin and a material with a perovskite structure disposed on the substrate; wherein the material with a perovskite structure has a chemical formula selected from ABX₃ and A₂BX₆, wherein A is a cation, B is a cation and X is an anion; and wherein the thermoplastic resin comprises an alkylene monomer and a monomer having acidic side groups.

In some examples, the printed substrate may comprise a substrate; and a liquid electrophotographically printed composition comprising a thermoplastic resin and a material with a perovskite structure disposed on the substrate; wherein the material with a perovskite structure has a chemical formula selected from ABX₃ and A₂BX₆, wherein A is a cation, B is a cation and X is an anion; and wherein the thermoplastic resin comprises a copolymer of an alkylene monomer and an ethylenically unsaturated monomer comprising an epoxide. In some examples, the printed substrate may comprise a substrate; and a liquid electrophotographically printed composition comprising a thermoplastic resin and a material with a perovskite structure disposed on the substrate; wherein the material with a perovskite structure has a chemical formula selected from ABX₃ and A₂BX₆, wherein A is a cation, B is a cation and X is an anion; and wherein the thermoplastic resin comprises a copolymer of an alkylene monomer, an ethylenically unsaturated monomer comprising an epoxide, and a monomer selected from a monomer having acidic side groups, a monomer having ester side groups and a mixture thereof. In some examples, the printed substrate may comprise a substrate; and a liquid electrophotographically printed composition comprising a thermoplastic resin and a material with a perovskite structure disposed on the substrate; wherein the material with a perovskite structure has a chemical formula selected from ABX₃ and A₂BX₆, wherein A is a cation, B is a cation and X is an anion; and wherein the thermoplastic resin comprises a copolymer of an alkylene monomer and a monomer having acidic side groups; and a copolymer of an alkylene monomer and an ethylenically unsaturated monomer comprising an epoxide. In some examples, the printed substrate may comprise a substrate; and a liquid electrophotographically printed composition comprising a thermoplastic resin and a material with a perovskite structure disposed on the substrate; wherein the material with a perovskite structure has a chemical formula selected from ABX₃ and A₂BX₆, wherein A is a cation, B is a cation and X is an anion; and wherein the thermoplastic resin comprises copolymer of an alkylene monomer and an ethylenically unsaturated monomer comprising an epoxide; and a copolymer of an alkylene monomer, an ethylenically unsaturated monomer comprising an epoxide, and a monomer selected from a monomer having acidic side groups, a monomer having ester side groups and a mixture thereof. In some examples, the printed substrate may comprise a substrate; and a liquid electrophotographically printed composition comprising a thermoplastic resin and a material with a perovskite structure disposed on the substrate; wherein the material with a perovskite structure has a chemical formula selected from ABX₃ and A₂BX₆, wherein A is a cation, B is a cation and X is an anion; and wherein the thermoplastic resin comprises a copolymer of an alkylene monomer and a monomer having acidic side groups and a copolymer of an alkylene monomer, an ethylenically unsaturated monomer comprising an epoxide, and a monomer selected from a monomer having acidic side groups, a monomer having ester side groups and a mixture thereof.

In some examples, the liquid electrophotographically printed composition may form a layer having a thickness of 0.1 μm or more, 0.2 μm or more, 0.3 μm or more, 0.4 μm or more, 0.5 μm or more, 0.6 μm or more, 0.7 μm or more, 0.8 μm or more, 0.9 μm or more, 1 μm or more. In some examples, the liquid electrophotographically printed composition may form a layer having a thickness of 1 μm or less, for example, 0.9 μm or less, 0.8 μm or less, 0.7 μm or less, 0.6 μm or less, 0.5 μm or less, 0.4 μm or less, 0.3 μm or less, 0.2 μm or less, 0.1 μm or less. In some examples, the liquid electrophotographically printed material may form a layer having a thickness of 0.1 μm to 1 μm, for example, 0.5 μm to 1 μm, 0.6 μm to 0.9 μm, 0.7 μm to 0.8 μm. In some examples, the liquid electrophotographically printed composition may form a layer having a thickness of 0.5 μm or more, for example, 0.6 μm or more, 0.7 μm or more, 0.8 μm or more, 0.9 μm or more, 1 μm or more. In some examples, the liquid electrophotographically printed composition may form a layer having a thickness of 1 μm or less, for example, 0.9 μm or less, 0.8 μm or less, 0.7 μm or less, 0.6 μm or less, 0.5 μm or less. In some examples, the liquid electrophotographically printed material may form a layer having a thickness of 0.5 μm to 1 μm, for example, 0.6 μm to 0.9 μm, 0.7 μm to 0.8 μm.

In some examples, the printed substrate may be a photovoltaic cell or an electronic device. In some examples, the printed substrate may be a photovoltaic cell, wherein the liquid electrophotographically printed composition forms the light harvesting active layer of the photovoltaic cell. In some examples, the printed substrate may be an electronic device, wherein the liquid electrophotographically printed composition forms a semiconductor component of the electronic device.

In some examples, the printed substrate may comprise a conductive substrate, an electron transport layer disposed on the conductive substrate, a light harvesting active layer disposed on the electron transport layer; a hole transport layer disposed on the light harvesting active layer; and a conductive layer disposed on the hole transport layer. In some examples, the material with a perovskite structure may be the light harvesting active layer.

Substrate

In some examples, the substrate may comprise any material capable of being liquid electrophotographically printed. In some examples, the substrate may comprise an electron transport layer for use in a photovoltaic cell.

In some examples, the substrate may comprise an electron transport layer. In some examples, the electron transport layer may be ZnO, alumina, titania or tin oxide. In some examples, the material with a perovskite structure may be disposed on the electron transport layer of the substrate.

In some examples, the electron transport layer may be disposed on the surface of an indium tin oxide coated polyethylene terephthalate layer.

In some examples, the substrate may be plastic, for example, polyethylene terephthalate.

### EXAMPLES

The following illustrates examples of the methods and other aspects described herein. Thus, these Examples should not be considered as limitations of the present disclosure, but are merely in place to teach how to make examples of the present disclosure.

Materials
Salts
CsBr: available from Sigma-Aldrich.
SnBr₂: available from Sigma-Aldrich.
CsI: available from Sigma-Aldrich.
Methylammonium Iodide (MAI): available from Sigma-Aldrich or TCI.
PbI₂: available from Sigma-Aldrich or TCI.
Resins
Nucrel® 699: a copolymer of ethylene and methacrylic acid, made with nominally 11 wt. % methacrylic acid (available form DuPont).
AC-5120: a copolymer of ethylene and acrylic acid with an acrylic acid content of 15 wt. % (available from Honeywell).
Poly(ethylene-co-glycidyl methacrylate) resin: a copolymer of ethylene and glycidyl methacrylate containing 6.5 to 9.0 wt. % glycidyl methacrylate with a melt index of 4.0 to 6.0 g/10 min (190° C./2.16 kg) (available from Aldrich as pellets under product number 430862).

Carrier Liquid
Isopar L™: an isoparaffinic oil comprising a mixture of C11-C13 isoalkanes (produced by Exxon Mobil™; CAS number 64742-48-9.

Charge Adjuvant
Aluminium stearate: available from Sigma-Aldrich
VCA: an aluminium stearate (available from Fishcher Scientific)

Charge Director

NCD (natural charge director): KT (natural soya lecithin in phospholipids and fatty acids), BBP (basic barium petronate, i.e., a barium sulfonate salt of a 21-26 carbon hydrocarbon alkyl, available from Cemtura™), and GT (dodecyl benzene sulfonic acid isopropyl amine, supplied by Croda™). The composition being 6.6 wt. % KT, 9.8 wt. % BBP and 3.6 wt. % GT and balance (80 wt. %) Isopar L™.

Resin Paste

Nucrel™ 699 and ACTH-5120 were combined in a ratio of 4:1 with Isopar™ L (from Chevron) at 42 wt. % solids. The mixture was mixed at 50 rpm in a Ross mixer and heated to 120° C. until a clear one phase solution (approximately 2 hours) was produced. The mixture was then cooled slowly to below 60° C. to give the swollen resin in Isopar™ L as a paste. The paste was diluted with Isopar™ L to 25 wt. % NVS.

Liquid Electrophotographic Ink Composition 1—CsBr

CsBr (2.5 g), the resin paste (9.2 g; at 25 wt. % NVS) and Al stearate (0.2 g) were combined with Isopar™ L in a glass container to give 100 g of a dispersion at 5 wt. % total NVS. To the glass container, 80 g of 0.9 mm ceramic media were added. The mixture was placed in a high powered shaker grinding tool (Fast&Fluid SK550 1.1 Shaker Skandex™) and was ground for 12 hours at 500 rpm to produce a CsBr-based liquid electrophotographic ink composition at 5 wt. % NVS. A charge director (NCD) in an amount of 50 mg/g of solids was added to provide the charged dispersion for liquid electrophotographic printing.

Liquid Electrophotographic Ink Composition 2—SnBr₂

SnBr₂ (3 g), resin paste (7.2 g; at 25 wt. % NVS) and Al stearate (0.2 g) were combined with Isopar™ L in a glass container to give a 100 g dispersion at 5 wt. % total NVS. To the glass container, 80 g of 0.9 mm ceramic media were added. The mixture was placed in a high power shaker grinding tool (Fast&Fluid SK550 1.1 Shaker Skandex™) and was ground for 12 hours at 500 rpm to produce a SnBr₂-based liquid electrophotographic ink composition at 5 wt. % NVS. A charge director (NCD) in an amount of 50 mg/g of solids was added to provide the charged dispersion for liquid electrophotographic printing.

### Example 1—In Situ Film Formation of Perovskite

Liquid electrophotographic ink composition 1 (a white colored ink comprising CsBr) was electroplated onto a polyethylene terephthalate (PET) substrate to form a layer with a thickness of typically 0.5 μm to 1 μm. Liquid electrophotographic ink composition 2 (comprising SnBr₂) was then applied by electroplating to form a layer with a thickness of typically 0.5 μm to 1 μm. The two layers were fused and dried on a hot plate at 100° C. for 2 min to give a colored perovskite film. It is believed that the heating provides the activation energy for the formation of the perovskite structure on the surface of the substrate.

Electroplating exploits the same phenomenon as liquid electrophotographic printing and has therefore been used to demonstrate that these ink compositions are capable of being liquid electrophotographically printed. In electroplating, two electrodes are placed in the liquid electrophotographic ink composition and a strong electric field is applied between the two electrodes. The substrate is attached to the positively charged electrode. The chargeable particles of the liquid electrophotographic ink composition are attracted to the positively charged electrode, forming a layer of the liquid electrophotographic ink composition on the substrate attached to the positively charged electrode. In liquid electrophotographic printing, a positively charged latent image is formed on the photoimaging plate (PIP) and the chargeable particles are attracted to the positively charged portions of the PIP. Thus, the formation of a layer of liquid electrophotographic ink composition on the substrate during electroplating demonstrates that the composition is capable of being used as a liquid electrophotographic ink composition.

Liquid Electrophotographic Ink Composition 3—Mix of Ink Compositions 1 and 2

Liquid electrophotographic ink composition 1 and liquid electrophotographic ink composition 2 were combined in a stoichiometric ratio, manually mixed for a few minutes and placed on a shelf for 2 hours. The white composition changed color, forming a dark colored CsSnBr₃-containing liquid electrophotographic ink composition at 5 wt. % NVS. A charge director (NCD) in an amount of 50 mg/g of solids was added to provide the charged dispersion for liquid electrophotographic printing. It is believed that the separate grinding of each liquid electrophotographic ink composition and manual mixing of the combined composition provides the activation energy for the formation of the perovskite structure.

### Example 2

Liquid electrophotographic ink composition 3 was deposited onto a PET substrate by electroplating.

Liquid Electrophotographic Ink Composition 4—In Situ Formation of CsSnBr₃

CsBr (1.25 g), SnBr₂ (1.5 g), resin paste (9.2 g; at 25 wt. % NVS) and Al stearate (0.2 g) were combined in a glass container. The dispersion was diluted with Isopar™ L to form a 100 g dispersion at 5 wt. % total NVS. To the glass container, 80 g of 0.9 mm ceramic media were added, and the mixture was ground in a high-power shaking tool (Fast&Fluid SK550 1.1 Shaker Skandex™) for 12 hours at 500 rpm to form a dark CsSnBr₃ perovskite based liquid electrophotographic ink composition. A charge director (NCD) in an amount of 50 mg/g of solids was added to provide the charged dispersion for liquid electrophotographic printing. It is believed that the grinding procedure provides the activation energy for the formation of the perovskite structure.

### Example 3

Liquid electrophotographic ink composition 4 was deposited onto a PET substrate by electroplating.

Test Results

A sample of the liquid electrophotographic ink composition 3 was dried. A comparison of the X-ray diffraction pattern obtained for the sample with those of CsSnBr₃ and Cs₂SnBr₆ (spectra obtained from a library of experimental XRD patterns) shows that a mixture of these two perovskite structures is present.

The dark color of the obtained perovskite mixtures in Isopar L (liquid electrophotographic ink compositions 3 and 4) was found to be stable for several months. In contrast, solutions for use in other methods of obtaining perovskite materials (e.g., by spray or spin coating techniques) cannot be stored. It is believed that the increased stability of the perovskite structure within the dispersion is due to the absence of polar molecules that, if present, interrupt the perovskite structure. Moreover, the hydrophobic nature of the carrier liquid (Isopar L) and thermoplastic resin in the composition prevent, to some extent, exposure of the perovskite structure to water.

Liquid electrophotographic ink compositions 1 (comprising CsBr) and 2 (comprising SnBr₂) were also found to be stable for several months.

### Example 5

A resin paste was prepared by mixing poly(ethylene-co-glycidyl methacrylate) resin (1000 g) with Isopar L (2000 g) in a ROSS mixer (33.3 wt. % NVS) and the mixture was mixed at 60 rpm at the mixing temperatures for the durations specified in the table below:

| Temperature [° C.] | Time [min] |
|---|---|
| 130 | 120 |
| 105 | 30 |
| 100 | 30 |
| 90 | 30 |
| 25 | 30 |

Three types of Perovskite LEP ink formulation comprising the poly(ethylene-co-glycidyl methacrylate) resin were prepared by following the procedure described for liquid electrophotographic ink composition 4 except that a 250 ml glass jar and 80 g of zirconia grinding balls (1 mm diameter) were used. A detailed samples composition is presented in the table below:

| | Salt | Salt | Perovskite | ABX₂ | | | Isopar |
|---|---|---|---|---|---|---|---|
| | AX | BX₂ | crystal | [wt. % | Resin | VCA | L |
| Ex. | ([g]) | ([g]) | obtained | NVS] | [g] | [g] | [g] |
| 5.1 | CsI | SnBr₂ | CsSnBr₂I | 77.5 | 0.93 | 0.05 | 28.83 |
| | (0.6) | (0.64) | | | | | |
| 5.2 | MAI | PbI₂ | MAPbI₃ | 77.5 | 0.93 | 0.05 | 28.83 |
| | 0.32 | (0.92) | | | | | |
| 5.3 | CsBr | PbI₂ | CsPbBrI₂ | 77.5 | 0.93 | 0.05 | 28.83 |
| | (0.39) | (0.85) | | | | | |

The presented formulations were mixed for 8 hours without heating to obtain 31.1 g of LEP ink composition at 5.0 wt. % NVS.

Test Procedures

For visual/fluorescence analyses, samples were diluted 20 fold (0.5 g formulation added to 9.5 g of Isopar L) and deposited on a polyethylene terephthalate—indium tin oxide (PET/ITO) substrate (the LEP ink was contacted with the ITO) by electroplating using a Q/M instrument (an electrodeposition instrument in which the LEP ink is placed between two electrodes and a high voltage is applied to deposit ink on a substrate located near one of the electrodes). Finally, the platted samples were heated to 120° C. for 5 minutes to cure the resin by ring-opening and cross-linking reactions of the epoxide groups of the poly(ethylene-co-glycidyl methacrylate). The ring-opening reaction may be initiated by nucleophilic groups on, for example, the surface of the substrate.

For X-ray diffraction analyses, the LEP ink formulations were dried in an oven on glass plates at 120° C.

Stability Analysis

The stability of the printed LEP ink compositions of Example 5 was visually assessed. Samples of the LEP ink composition were deposited on a PET-ITO substrate by electroplating and then cured by heating at 120° C. for 5 min before being visually inspected for changes in color or morphology. Visual inspection was performed on days 2, 7 and 30. No significant changes in color or morphology were detected after 30 days for LEP ink formulations according to Examples 5.1, 5.2 or 5.3. Formulations according to Examples 5.1, 5.2 and 5.3 were found to be even more stable to oxygen and water than formulations according to Examples 1 to 4.

Analyses of Stability of Fluorescence

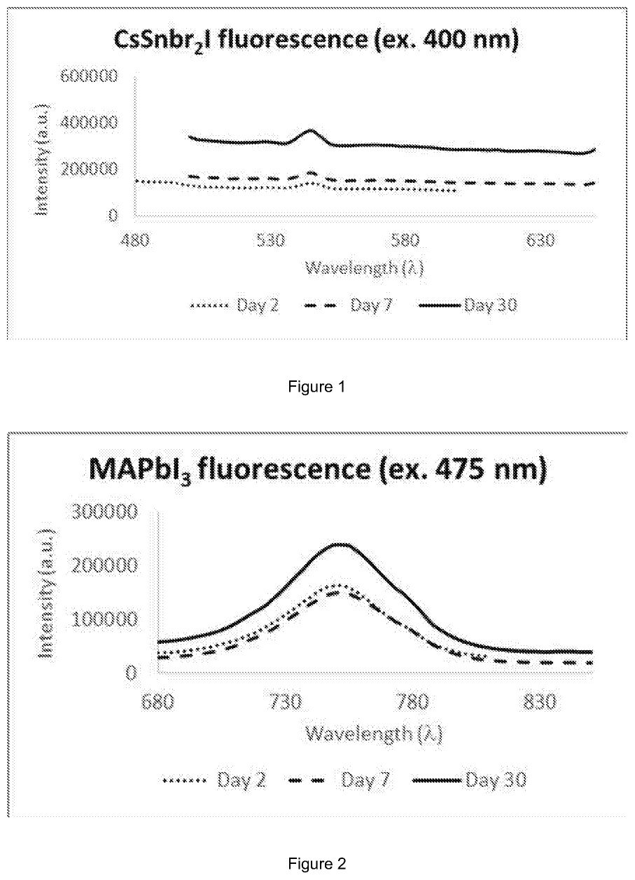

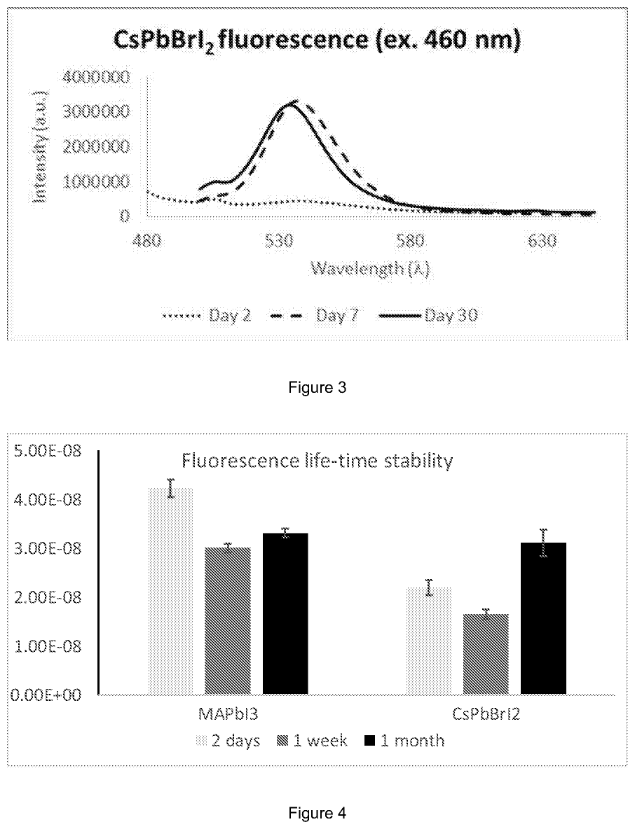

Fluorescence intensity was measured by using a Fuoroog™-3 spectrometer by Horiba. FIGS. 1 to 3 show the fluorescence intensity curves of the Example 5.1, 5.2 and 5.3 LEP ink compositions, respectively, measured after plating on a PET/ITO substrate and curing on days 2, 7 and 30. The excitation wavelengths are indicated in the Figures.

As shown in FIGS. 1 to 3, each sample showed different fluorescence behavior. For LEP ink composition in which poly(ethylene-co-glycidyl methacrylate) was used as the thermoplastic resin, MAPbI₃ showed significant fluorescence intensity throughout the fluorescence stability test whereas CsPbBrI₂ showed a large increase in fluorescence intensity at day 7 and maintained the high fluorescence intensity until day 30 and CsSnBr₂I did not show significant fluorescence intensity at all any time. Nevertheless, no degradation in fluorescence intensity was observed for the examined samples. Conversely, an increase in fluorescent intensity was observed.

Analysis of Stability of Fluorescence Lifetime

FIG. 4 shows fluorescence life-time measurements for LEP ink compositions the Example 5.2 and 5.3 LEP ink compositions measured after plating on a PET/ITO substrate and curing on days 2, 7 and 30.

As shown in FIG. 4, both samples show good stability of the fluorescence lifetime over the 30 days analyzed. A small degradation in fluorescence lifetime was recorded for MAPbI₃ (˜20% after 30 days) and a slight increase in fluorescence lifetime was recorded for CsPbBrI₂ (˜20% after 30 days). Humidity was about 60%.

In comparison, for a typical fully layered MABbl₃ solar cell device (in which the perovskite layer is covered by a hole-transport layer (HTL) and a conductive electrode layer which protects it from humidity) a ˜20% degradation in cell efficiency is seen after 50 days exposed to air with only 45% humidity (J. Cao, C. Li, X. Lv, X. Feng, R. Meng, Y. Wu, Y. Tang, Efficient Grain Boundary Suture by Low-cost Tetra-ammonium Zinc Phthalocyanine for Stable Perovskite Solar Cells with Expanded Photo-response, J. Am. Chem. Soc. 2018, 140, 11577).

Crystal Structure Stability Analyses by X-Ray Diffraction

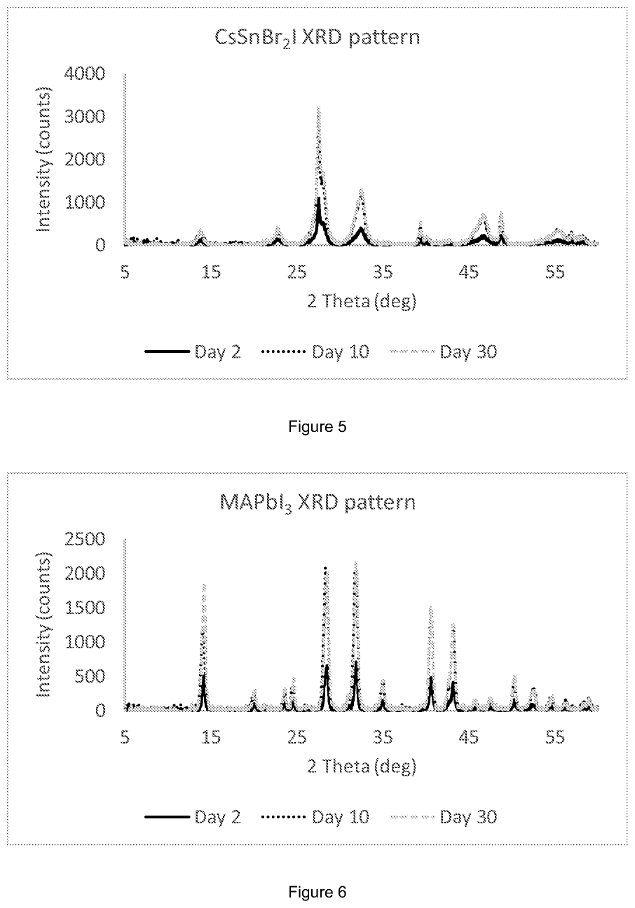

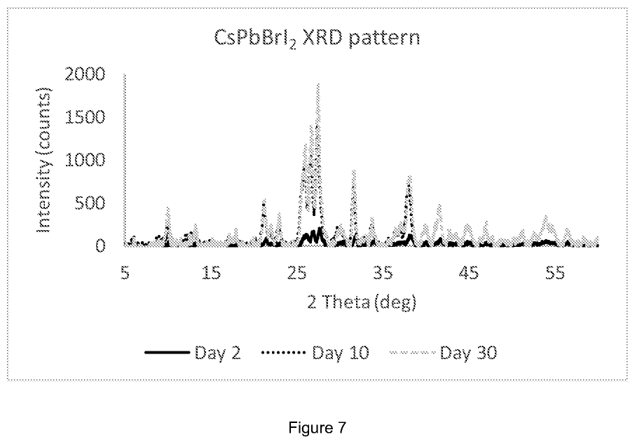

FIGS. 5 to 7 show the XRD crystal structure measurements for Example 5.1, 5.2 and 5.3 LEP ink compositions, respectively, measured after LEP ink composition samples were dried in a glass petri dish and cured. The dried samples were scratched off the petri dishes and ground to obtain powders for XRD examination. XRD spectra were taken on days 2, 7 and 30 after curing.

Perovskite degradation studies have reported that perovskite solar cells (PSCs) are severely affected by moisture and oxygen and thus show environmental sensitivity. For example, the degradation process of MAPbI₃ perovskite by hydrolysis reactions is represented by following chemical equations (G. Niu, W. Li, F. Meng, L. Wang, H. Dong, Y. Qiu, Study on the stability of CH₃NH₃PbI₃ films and the effect of post-modification by aluminum oxide in all-solid-state hybrid solar cells, J. Mater. Chem. A 2, 2014, 705-710):

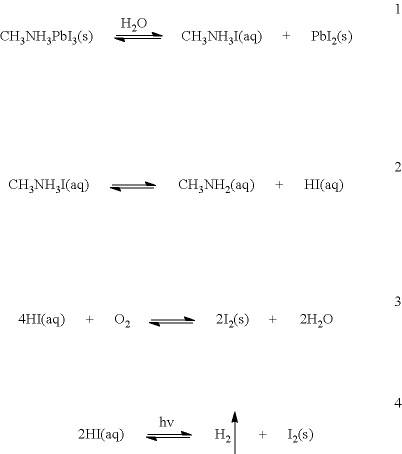

Therefore, since MAI and PbI₂ are the main degradation products, the presence of these compounds in the X-ray diffraction patterns would indicate that the degradation process is occurring. In the same manner, the presence of CsI, CsBr, SnI₂, SnBr₂ and SnBrI would indicate that the degradation process of CsSnBr₂I is occurring and the presence of CsI, CsBr, PbI₂, PbBr₂ and PbBrI would indicate that degradation of CsPbBrI₂ is occurring.

Since none of the expected degradation products appear in the examined perovskite X-ray diffraction patterns, it is considered that the examined perovskite layers show good stability after one month in an ambient environment.

The following numbered paragraphs define particular embodiments of the present disclosure:

1. A method of producing a material with a perovskite structure on a substrate by liquid electrophotographic (LEP) printing, the method comprising:
either
   liquid electrophotographically printing onto the substrate a composition comprising a dispersion of a salt AX and a thermoplastic resin in a carrier liquid;
   liquid electrophotographically printing onto the substrate a composition comprising a dispersion of a salt selected from BX₂ and BX₄ and a thermoplastic resin in a carrier liquid; and heat treating the printed compositions to form the material with a perovskite structure;
or
   liquid electrophotographically printing onto the substrate a composition comprising a dispersion of a material with a perovskite structure and a thermoplastic resin in a carrier liquid to form the material with a perovskite structure;
wherein the material with a perovskite structure has a chemical formula selected from ABX₃ and A₂BX₆;
wherein A is a cation, B is a cation and X is an anion;
wherein the thermoplastic resin comprises a copolymer of an alkylene monomer and a monomer having acidic side groups.

2. The method according to paragraph 1, wherein A is selected from a monovalent metal cation, a monovalent organic cation, or a mixture thereof.

3. The method according to paragraph 1, wherein the salt selected from BX₂ and BX₄ is BX₂ and B is a divalent metal cation or wherein the salt selected from BX₂ and BX₄ is BX₄ and B is a tetravalent metal cation.

4. The method according to paragraph 1, wherein X is a halide ion, for example, selected from iodide, bromide, chloride and mixtures thereof.

5. The method according to paragraph 1, wherein A is selected from methylammonium (MA), formamidinium (FA), rubidium (Rb), caesium (Cs), and mixtures thereof.

6. The method according to paragraph 1, wherein B is selected from lead (Pb), germanium (Ge), tin (Sn), antimony (Sb), bismuth (Bi), copper (Cu), manganese (Mn), cobalt (Co) and mixtures thereof.

7. The method according to paragraph 1, wherein the composition comprising a dispersion of a material with a perovskite structure and a thermoplastic resin in a carrier liquid was formed by
combining a liquid electrophotographic ink composition comprising a dispersion of a salt AX and a thermoplastic resin in a carrier liquid with a liquid electrophotographic ink composition comprising a dispersion of a salt selected from BX₂ and BX₄ and a thermoplastic resin in a carrier liquid;
   or
dispersing a salt AX, a salt selected from BX₂ and BX₄, and a thermoplastic resin in a carrier liquid.

8. The method according to paragraph 1, wherein the heat treatment was performed at a temperature of 200° C. or less.

9. The method according to paragraph 1, wherein the thermoplastic resin comprises a copolymer of ethylene and a monomer selected from acrylic acid and methacrylic acid.

10. The method according to paragraph 1, wherein the substrate comprises an electron transport layer onto which the material with a perovskite structure is applied.

11. The method according to paragraph 1, wherein the carrier liquid is a hydrocarbon.

12. The method according to paragraph 1, wherein the carrier liquid is a branched chain hydrocarbon comprising 5 to 15 carbon atoms.

13. An ink set comprising:
a liquid electrophotographic ink composition comprising a dispersion of a material with a perovskite structure and a thermoplastic resin in a carrier liquid;
   or
a liquid electrophotographic ink composition comprising a dispersion of a salt AX and a thermoplastic resin in a carrier liquid; and a liquid electrophotographic ink composition comprising a dispersion of a salt selected from BX₂ and BX₄ and a thermoplastic resin in a carrier liquid;
   wherein the material with a perovskite structure has a chemical formula selected from ABX₃ and A₂BX₆;
   wherein A is a cation, B is a cation and X is an anion;
   wherein the thermoplastic resin comprises a copolymer of an alkylene monomer and a monomer having acidic side groups.

14. The ink set according to paragraph 1, wherein the carrier liquid comprises a hydrocarbon.

15. A printed substrate comprising:
a substrate; and
a liquid electrophotographically printed composition comprising a thermoplastic resin and a material with a perovskite structure disposed on the substrate;
wherein the material with a perovskite structure has a chemical formula selected from ABX₃ and A₂BX₆;
wherein A is a cation, B is a cation and X is an anion; and
wherein the thermoplastic resin comprises an alkylene monomer and a monomer having acidic side groups.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims. Unless otherwise stated, the features of any dependent claim can be combined with the features of any of the other dependent claims and any of the independent claims.

1. A method of producing a material with a perovskite structure on a substrate by liquid electrophotographic (LEP) printing, the method comprising:
either
liquid electrophotographically printing onto the substrate a composition comprising a dispersion of a salt AX and a thermoplastic resin in a carrier liquid;
liquid electrophotographically printing onto the substrate a composition comprising a dispersion of a salt selected from BX₂ and BX₄ and a thermoplastic resin in a carrier liquid; and
heat treating the printed compositions to form the material with a perovskite structure;
or
liquid electrophotographically printing onto the substrate a composition comprising a dispersion of a material with a perovskite structure and a thermoplastic resin in a carrier liquid to form the material with a perovskite structure;
wherein the material with a perovskite structure has a chemical formula selected from ABX₃ and A₂BX₆;
wherein A is a cation, B is a cation and X is an anion;
wherein the thermoplastic resin comprises:
a copolymer of an alkylene monomer and a monomer having acidic side groups; and/or
a copolymer of an alkylene monomer and an ethylenically unsaturated monomer comprising an epoxide; and/or
a copolymer of an alkylene monomer, an ethylenically unsaturated monomer comprising an epoxide, and a monomer selected from a monomer having acidic side groups, a monomer having ester side groups and a mixture thereof.

2. The method according to claim 1, wherein the thermoplastic resin comprises a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof.

3. The method according to claim 1, wherein A is selected from a monovalent metal cation, a monovalent organic cation, or a mixture thereof; and/or
wherein the salt selected from BX₂ and BX₄ is BX₂ and B is a divalent metal cation or wherein the salt selected from BX₂ and BX₄ is BX₄ and B is a tetravalent metal cation.

4. The method according to claim 1, wherein X is a halide ion, for example, selected from iodide, bromide, chloride and mixtures thereof; and/or
wherein A is selected from methylammonium (MA), formamidinium (FA), rubidium (Rb), caesium (Cs), and mixtures thereof; and/or
wherein B is selected from lead (Pb), germanium (Ge), tin (Sn), antimony (Sb), bismuth (Bi), copper (Cu), manganese (Mn), cobalt (Co) and mixtures thereof;
and/or
wherein the liquid carrier is a hydrocarbon.

5. The method according to claim 1, wherein the composition comprising a dispersion of a material with a perovskite structure and a thermoplastic resin in a carrier liquid was formed by
combining a liquid electrophotographic ink composition comprising a dispersion of a salt AX and a thermoplastic resin in a carrier liquid with a liquid electrophotographic ink composition comprising a dispersion of a salt selected from BX₂ and BX₄ and a thermoplastic resin in a carrier liquid;
or
dispersing a salt AX, a salt selected from BX₂ and BX₄, and a thermoplastic resin in a carrier liquid.

6. The method according to claim 2, wherein heat treatment of the printed composition to form the material with a perovskite structure additionally cures the thermoplastic resin.

7. The method according to claim 2, further comprising curing the thermoplastic resin.

8. The method according to claim 7, wherein curing the thermoplastic resin comprises heating the thermoplastic resin.

9. The method according to claim 1, wherein the heat treatment was performed at a temperature of 200° C. or less.

10. The method according to claim 1, wherein the thermoplastic resin comprises
a copolymer of ethylene and a monomer selected from acrylic acid and methacrylic acid; and/or
a copolymer of ethylene and a monomer selected from glycidyl methacrylate and glycidyl acrylate; and/or
a copolymer of ethylene, a monomer selected from glycidyl methacrylate and glycidyl acrylate and a monomer selected from vinyl acetate, an alkyl ester of acrylic acid and an alkyl ester of methacrylic acid.

11. The method according to claim 1, wherein the substrate comprises an electron transport layer onto which the material with a perovskite structure is applied.

12. An ink set comprising:
a liquid electrophotographic ink composition comprising a dispersion of a material with a perovskite structure and a thermoplastic resin in a carrier liquid;
or
a liquid electrophotographic ink composition comprising a dispersion of a salt AX and a thermoplastic resin in a carrier liquid; and
a liquid electrophotographic ink composition comprising a dispersion of a salt selected from BX₂ and BX₄ and a thermoplastic resin in a carrier liquid;
wherein the material with a perovskite structure has a chemical formula selected from ABX₃ and A₂BX₆;
wherein A is a cation, B is a cation and X is an anion;
wherein the thermoplastic resin comprises:
a copolymer of an alkylene monomer and a monomer having acidic side groups; and/or
a copolymer of an alkylene monomer and an ethylenically unsaturated monomer comprising an epoxide; and/or
a copolymer of an alkylene monomer, an ethylenically unsaturated monomer comprising an epoxide, and a monomer selected from a monomer having acidic side groups, a monomer having ester side groups and a mixture thereof.

13. A printed substrate comprising:
a substrate; and
a liquid electrophotographically printed composition comprising a thermoplastic resin and a material with a perovskite structure disposed on the substrate;
wherein the material with a perovskite structure has a chemical formula selected from ABX₃ and A₂BX₆;
wherein A is a cation, B is a cation and X is an anion; and
wherein the thermoplastic resin comprises:
a copolymer of an alkylene monomer and a monomer having acidic side groups; and/or
a copolymer of an alkylene monomer and an ethylenically unsaturated monomer comprising an epoxide; and/or
a copolymer of an alkylene monomer, an ethylenically unsaturated monomer comprising an epoxide, and a monomer selected from a monomer having acidic side groups, a monomer having ester side groups and a mixture thereof.

14. The printed substrate of claim 13, wherein the thermoplastic resin comprises a copolymer of an alkylene monomer and an ethylenically unsaturated monomer comprising an epoxide; and/or a copolymer of an alkylene monomer, an ethylenically unsaturated monomer comprising an epoxide, and a monomer selected from a monomer having acidic side groups, a monomer having ester side groups and a mixture thereof; and
wherein the thermoplastic resin has been cured.

15. The printed substrate of claim 14, wherein the thermoplastic resin has been cured by a ring-opening reaction of the epoxide and/or a cross-linking reaction of the epoxide.
